(19) United States
(12) Patent Application Publication
(10) Pub. No.: US 2026/0192632 A1
(43) Pub. Date: Jul. 9, 2026

(54) VEHICLE AIR CONDITIONING DEVICE

(71) Applicant: SANDEN CORPORATION, Isesaki-shi, Gunma (JP)

(72) Inventors: Wataru IWAZAKI, Isesaki-shi, Gunma (JP); Osamu TAKAZAWA, Isesaki-shi, Gunma (JP); Masaaki SATO, Isesaki-shi, Gunma (JP); Kenzo OBA, Isesaki-shi, Gunma (JP)

(73) Assignee: SANDEN CORPORATION, Isesaki-shi, Gunma (JP)

(21) Appl. No.: 19/127,655

(22) PCT Filed: Oct. 25, 2023
(86) PCT No.: PCT/JP2023/038417

§ 371 Date: May 6, 2025

(30) Foreign Application Priority Data
Nov. 25, 2022 (JP) 2022-188069

(51) Int. Cl. B60H 1/32

(52) U.S. Cl. CPC B60H 1/321; B60H 1/32284

(57) ABSTRACT

A vehicle air-conditioning apparatus includes a refrigerant circuit including a compressor, an indoor heat exchange unit, an air conditioning circuit including an external heat exchange unit, and a controller that controls the refrigerant circuit. The controller is feasible of selectively executing an outside air heat absorbing/heating operation in which heat is absorbed by the external heat exchange unit and a defrosting operation in which the external heat exchange unit is defrosted. The controller calculates travel time to a destination and an operation time of the outside air heat absorbing/heating operation until the outside air heat is not absorbed by the external heat exchange unit due to frosting. When the travel time is longer than the operation time, the controller executes the defrosting operation such that at least the operation time is equal to or longer than the travel time.

### CROSS-REFERENCE TO RELATED APPLICATIONS

This application is a U.S. National Stage Patent Application under 37 U.S.C. § 371 of International Patent Application No. PCT/JP2023/038417, filed on Oct. 23, 2023, which claims the benefit of Japanese Patent Application No. JP 2022-188069, filed on Nov. 25, 2022, the disclosures of each of which are incorporated herein by reference in their entirety.

### TECHNICAL FIELD

The present invention relates to a vehicle air-conditioning apparatus.

### BACKGROUND ART

Heretofore, as an air conditioner applicable to a vehicle such as a hybrid vehicle or an electric vehicle, there has been developed an air conditioner including a compressor, a radiator, a heat sink, and a refrigerant circuit to which an external heat exchange unit is connected, in which the refrigerant discharged from the compressor is caused to radiate heat in the radiator, the refrigerant dissipated in the radiator is caused to absorb heat in the external heat exchange unit to heat the vehicle interior, and the refrigerant discharged from the compressor is caused to radiate heat in the external heat exchange unit and caused to absorb heat in the heat sink to cool the vehicle interior.

In addition, when the vehicle interior is heated, the refrigerant absorbs heat in the external heat exchange unit and has a low temperature, so that moisture in the outside air adheres to the external heat exchange unit as frost. When the frost formation on the external heat exchange unit grows, heat exchange with the outside air is hindered, so that the heating performance is deteriorated. Therefore, the high-temperature refrigerant discharged from the compressor flows to the external heat exchange unit to dissipate heat, and thus the external heat exchange unit is deforested (see, for example, Patent Literature 1.)

Further, there is also known a technique in a refrigeration cycle device that absorbs heat from outside air, for the purpose of performing defrosting as efficiently as possible, in which the estimation of a frost formation state and presence or absence of defrosting operation are determined based on a temperature of cooling water to control defrosting (see, for example, Patent Literature 2.)

### CITATION LIST

### Patent Literature

Patent Literature 1: JP-A-2011-237052
Patent Literature 2: JP-A-2022-51623

### SUMMARY OF INVENTION

### Problems to be Solved by Invention

However, in the case of defrosting control in which the estimation of the frost formation state and the presence or absence of the defrosting operation are determined based on the temperature of the cooling water as in Patent Literature 2, power may be wasted by the defrosting operation. Specifically, for example, frost formation may not progress to such an extent that outside air heat absorption heating becomes unfeasible before arrival at the destination, for example, due to gradual progress of frost formation or a short distance to the destination. Even in such a case, when the defrosting is executed by the determination based on the temperature of the cooling water, the defrosting operation may be performed more than necessary. In addition, for example, when the defrosting operation is executed in a state where the frost formation does not progress so much, the traveling of the vehicle may end while remaining the reserve power for the outside air heat absorbing/heating operation, and in that case, the power consumption related to the defrosting operation and the performance of the outside air heat absorbing/heating operation are not possible to use, and the energy saving of the entire vehicle air-conditioning apparatus does not proceed, and there is a problem that the cruising distance of the vehicle decreases.

Therefore, an object of the present invention is to provide a vehicle air-conditioning apparatus capable of suppressing waste of power by avoiding execution of unnecessary defrosting operation and utilizing the performance of the outside air heat absorbing/heating operation as much as possible.

### Solution to Problems

The present invention relates to: a vehicle air-conditioning apparatus including: an air conditioning circuit having a refrigerant circuit, an indoor heat exchange unit, and an external heat exchange unit, the refrigerant circuit including a compressor; and a controller that controls the refrigerant circuit, the controller selectively executing an outside air heat absorbing/heating operation that absorbs heat in the external heat exchange unit and a defrosting operation that defrosts the external heat exchange unit, in which the controller calculates a travel time to a destination and operation time of an outside air heat absorbing/heating operation until outside air heat absorption becomes unfeasible in the external heat exchange unit due to frosting, and when the travel time is longer than the operation time, the controller executes the defrosting operation such that at least the operation time is equal to or longer than the travel time.

### Effects of Invention

According to the present invention, it is possible to provide a vehicle air-conditioning apparatus capable of suppressing waste of power by avoiding execution of unnecessary defrosting operation and utilizing the performance of the outside air heat absorbing/heating operation as much as possible.

### BRIEF DESCRIPTION OF DRAWINGS

FIG. 1 is a schematic view showing a vehicle air-conditioning apparatus according to a first embodiment of the present invention.

FIG. 2 is a schematic view showing the vehicle air-conditioning apparatus according to the first embodiment.

FIG. 3 is a schematic view showing the vehicle air-conditioning apparatus according to the first embodiment.

FIG. 4 is a schematic view showing the vehicle air-conditioning apparatus according to the first embodiment.

FIG. 5(A) is a block diagram showing a hardware configuration of a controller of the vehicle air-conditioning apparatus according to the first embodiment, and FIG. 5(B) is a block diagram showing a functional configuration of the controller.

FIGS. 6(A), 6(B), and 6(C) show schematic views of air conditioning operation patterns in the vehicle air-conditioning apparatus according to the first embodiment.

FIGS. 7(A), 7(B), and 7(C) show schematic views of air conditioning operation patterns in the vehicle air-conditioning apparatus according to the first embodiment.

FIGS. 8(A) and 8(B) show schematic views of air conditioning operation patterns in the vehicle air-conditioning apparatus according to the first embodiment.

FIGS. 9(A) and 9(B) show schematic views of air conditioning operation patterns in the vehicle air-conditioning apparatus according to the first embodiment.

FIGS. 10(A) and 10(B) show schematic views of air conditioning operation patterns in the vehicle air-conditioning apparatus according to the first embodiment.

FIG. 11 is a flowchart showing a flow of an air conditioning operation process in the vehicle air-conditioning apparatus according to the first embodiment.

FIG. 12 is a flowchart showing a flow of an air conditioning operation process in the vehicle air-conditioning apparatus according to the first embodiment.

FIG. 13 is a schematic view showing a vehicle air-conditioning apparatus according to a second embodiment of the present invention.

FIG. 14 is a schematic view showing the vehicle air-conditioning apparatus according to the second embodiment of the present invention.

FIG. 15 is a schematic view showing the vehicle air-conditioning apparatus according to the second embodiment of the present invention.

FIG. 16 is a schematic view showing the vehicle air-conditioning apparatus according to the second embodiment of the present invention.

FIG. 17 is a schematic view showing a vehicle air-conditioning apparatus according to a third embodiment of the present invention.

FIG. 18 is a schematic view showing the vehicle air-conditioning apparatus according to the third embodiment of the present invention.

FIG. 19 is a schematic view showing an air conditioning operation pattern in the vehicle air-conditioning apparatus according to the third embodiment.

### DESCRIPTION OF EMBODIMENTS

Hereinafter, embodiments of the present invention will be described in detail with reference to the drawings. In the following description, the same reference signs denote portions of the same functions, and redundant descriptions in the drawings are appropriately omitted.

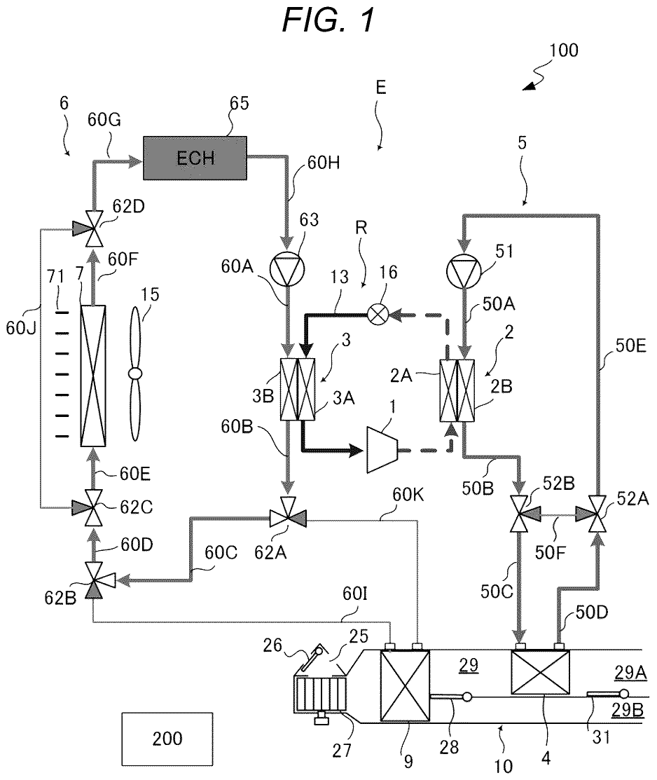

FIG. 1 is a schematic diagram showing an example of a main configuration including a refrigerant circuit R in a vehicle air-conditioning apparatus 100 according to a first embodiment of the present invention. The vehicle air-conditioning apparatus 100 of the present embodiment may be mounted on a vehicle powered only by the internal combustion engine, but is suitably used for vehicles such as a hybrid electric vehicle (HEV) in which it is difficult to secure a sufficient amount of heat only by the waste heat of the internal combustion engine as compared with a vehicle powered only by the internal combustion engine, and an electric vehicle (EV) in which heating is unfeasible by the waste heat of the internal combustion engine. The vehicle such as an HEV or an EV is mounted with a battery (e.g., a lithium battery), and is driven and travels by supplying power charged in the battery from an external power source to a motor unit including a traveling motor. The vehicle air-conditioning apparatus 100 is also driven by power supplied from the battery.

### <Overall Configuration>

As shown in FIG. 1, the vehicle air-conditioning apparatus 100 according to the first embodiment includes an air conditioning circuit E and a controller 200. The air conditioning circuit E shown in FIG. 1 is an example, and includes the refrigerant circuit R, an indoor heat exchange unit 4, and an external heat exchange unit 7. The vehicle air-conditioning apparatus 100 according to the present embodiment performs air conditioning (heating, cooling, dehumidifying, and deforesting) of the vehicle interior by performing a heat pump operation using the refrigerant circuit R. Note that in the following description, the refrigerant refers to a circulation medium of the refrigerant circuit R with a state change in a heat pump (compression, condensation, expansion, and evaporation), and the heat medium refers to a medium that absorbs heat and dissipates heat without such a state change.

### (Refrigerant Circuit)

The refrigerant circuit R includes a compressor 1, a first heat exchanger 2, an expansion mechanism 16, a second heat exchanger 3, and the like connected by a refrigerant pipe 13. The compressor 1 sucks and compresses the refrigerant from the upstream side in the refrigerant circuit R, and discharges the refrigerant as a high-temperature and high-pressure gas toward the downstream side. A type of the compressor 1 is not particularly limited, but for example, a piston type or scroll type electric compressor is adopted. Although not shown in the drawing, an accumulator that performs liquid separation from the refrigerant is provided on the upstream side of the compressor 1 in the refrigerant circuit R. The refrigerant circuit R causes the refrigerant changed into high-temperature and high-pressure gas by the compressor 1 to pass through the first heat exchanger 2 to dissipate heat from the refrigerant, thereby cooling the refrigerant. The refrigerant having passed through the first heat exchanger 2 is decompressed by the expansion mechanism 16 and allowed to pass through the second heat exchanger 3 to absorb heat. Then, the low-pressure refrigerant is compressed again by the compressor 1. This circulation is repeated.

### (First Heat Exchanger)

The first heat exchanger 2 is a refrigerant-heat medium heat exchanger having a refrigerant channel 2A and a heat medium channel 2B. The refrigerant channel 2A is connected to the refrigerant circuit R, and the heat medium channel 2B is connected to a first heat medium circuit 5 described later. The refrigerant channel 2A of the first heat exchanger 2 constitutes a part of the refrigerant circuit R and functions as a radiator of the refrigerant circuit R. The heat medium channel 2B of the first heat exchanger 2 constitutes a part of the first heat medium circuit 5, and functions as a heat sink of the first heat medium circuit 5.

### (Expansion Mechanism)

The expansion mechanism 16 includes an expansion valve, a capillary tube, or the like, and decompresses and expands the high-pressure refrigerant having passed through the first heat exchanger 2 to obtain a low-pressure refrigerant.

### (Second Heat Exchanger)

The second heat exchanger 3 is a refrigerant-heat medium heat exchanger having a refrigerant channel 3A and a heat medium channel 3B. The refrigerant channel 3A is connected to the refrigerant circuit R, and the heat medium channel 3B is connected to a second heat medium circuit 6 to be described later. The refrigerant channel 3A of the second heat exchanger 3 constitutes a part of the refrigerant circuit R and functions as a heat sink of the refrigerant circuit R. The heat medium channel 3B of the second heat exchanger 3 constitutes a part of the second heat medium circuit 6, and functions as a radiator of the second heat medium circuit 6.

### (First Heat Medium Circuit)

The first heat medium circuit 5 is a circuit through which a heat medium capable of exchanging heat with the refrigerant in refrigerant circuit R circulates, and includes, for example, a circulation pump 51, the first heat exchanger 2, a heater core 4 of an HVAC unit 10, a pipe 50 (50A, 50B, 50C, 50D, 50E, 50F), and a three-way valve 52 (52A, 52B.) The outlet of the circulation pump 51 communicates with the heat medium channel 2B of the first heat exchanger 2 via the pipe 50A. The heat medium channel 2B is connected to the three-way valve 52B via the pipe 50B.

The inlet of the three-way valve 52B is connected to the pipe 50B, one outlet of the three-way valve 52B communicates with the inlet of the heater core 4 via the pipe 50C, and the other outlet of the three-way valve 52B communicates with one inlet of the three-way valve 52A via the pipe 50F. The outlet of the heater core 4 is connected to the other inlet of the three-way valve 52A via the pipe 50D. The outlet of the three-way valve 52A communicates with the inlet of the circulation pump 51 via the pipe 50E.

The heater core 4 is disposed in a device called the HVAC (Heating Ventilation and Air-Conditioning) unit 10 provided in the vehicle.

### (HVAC Unit)

The HVAC unit 10 is formed of an air flow passage 29 that introduces outside air or inside air from one end side and supplies air into the vehicle interior from the other end side. Inside the HVAC unit 10, an indoor blower 27, a heat sink 9, an air mix damper 28, and the heater core 4 are provided. In the air flow passage 29 on the air upstream side of the heat sink 9, suction ports of an outside air suction port and an inside air suction port are formed (represented as a suction port 25 in FIG. 1.) The suction port 25 is provided with a suction switching damper 26. The suction switching damper 26 appropriately switches between inside air (inside air circulation) that is air inside the vehicle interior and outside air (outside air introduction) that is air outside the vehicle interior to introduce the air into the air flow passage 29 from the suction port 25. On the air downstream side of the suction switching damper 26, an indoor blower 27 that feeds the introduced inside air and outside air to the air flow passage 29 is provided.

The indoor blower 27 is provided on one end side of the HVAC unit 10, sucks outside air or inside air when driven, and discharges the sucked outside air or inside air to the other end side. The heat sink 9 is provided on the downstream side of the indoor blower 27. All the air blown out from the indoor blower 27 passes through the heat sink 9. On the downstream of the heat sink 9, the air flow passage 29 can be divided into two channels 29A and 29B. The two channels 29A and 29B merge on the downstream side, and the heater core 4 is disposed in the middle of one channel 29A.

The air mix damper 28 is rotatable between a position where the channel 29A on the downstream of the heat sink 9 is opened to close the channel 29B and a position where the channel 29A is closed to open the channel 29B. When the air mix damper 28 is at a position to open the channel 29A and close the channel 29B, all the air having passed through the heat sink 9 passes through the channel 29A. When the air mix damper 28 is at a position to close the channel 29A and open the channel 29B, all the air having passed through the heat sink 9 bypasses the channel 29A. When the air mix damper 28 is at a position to open both the channel 29A and the channel 29B, a part of the air having passed through the heat sink 9 passes through the channel 29A, and the rest detours around the channel 29A. On the downstream side of the HVAC unit 10, the air having passed through the channel 29A and the air having detoured around the channel 29A are mixed.

### (Second Heat Medium Circuit)

The second heat medium circuit 6 is a circuit through which a heat medium capable of exchanging heat with the refrigerant of a heat supply device 65 and the refrigerant circuit R circulates, and includes, for example, a circulation pump 63, the second heat exchanger 3, a radiator that serves as the external (outdoor) heat exchange unit 7, the heat supply device 65, the heat sink 9 of the HVAC unit 10, a pipe 60 (60A to 60K), a three-way valve 62 (62A, 62B, 62C, 62D), and the like. The heat supply device 65 is a device that serves as a heat source which supplies heat to the air conditioning circuit E, and here, as an example, the device is an electric coolant heater (ECH) that heats a heat medium.

The external heat exchange unit 7 has a grill shutter 71, and an outdoor blower 15 is provided in the its vicinity. By putting the grill shutter 71 in the open state and forcibly ventilating the outside air to the external heat exchange unit 7 with the outdoor blower 15, heat exchange between the outside air and the refrigerant is performed, and the outside air is ventilated to the external heat exchange unit 7 even while the vehicle is stopped.

The outlet of the circulation pump 63 communicates with the heat medium channel 3B of the second heat exchanger 3 via the pipe 60A. The heat medium channel 3B is connected to one end of the external heat exchange unit 7 via the pipe 60B, the three-way valve 62A, the pipe 60C, the three-way valve 62B, the pipe 60D, the three-way valve 62C, and the pipe 60E. The other end of the external heat exchange unit 7 is connected to the inlet of the heat supply device 65 via the pipe 60F, the three-way valve 62D, and the pipe 60G. The outlet of the heat supply device 65 is connected to the inlet of the circulation pump 63 via the pipe 60H.

The inlet of the three-way valve 62A communicates with the heat medium channel 3B of the second heat exchanger 3 via the pipe 60B, one outlet of the three-way valve 62A is connected to the pipe 60C, and the other outlet of the three-way valve 62A communicates with the inlet of the heat sink 9 of HVAC unit 10 via the pipe 60K. The three-way valve 62B has one inlet connected to the pipe 60C, the other inlet communicates with the outlet of the heat sink 9 of the HVAC unit 10 via the pipe 60I, and the outlet is connected to the pipe 60D. In the three-way valve 62C, one inlet is connected to the pipe 60D, one outlet is connected to the pipe 60J, and the other outlet communicates with one end of the external heat exchange unit 7 via the pipe 60E. One inlet of the three-way valve 62D communicates with the other end of the external heat exchange unit 7 via the pipe 60F, the other inlet of the three-way valve 62D is connected to the pipe 60J, and the outlet of the three-way valve 62D communicates with the inlet of the heat supply device 65 via the pipe 60G. The pipe 60J serves as a bypass path that bypasses the external heat exchange unit 7. By switching the three-way valves 62C and 62D, the channel of the heat medium between the two-way valves 62C and 62D can be switched to the channel of the pipe 60E, the external heat exchange unit 7, and the pipe 60F, and the channel of the pipe 60J.

### <Air Conditioning Operation>

Hereinafter, the type of air conditioning operation in the vehicle air-conditioning apparatus 100 will be described. The vehicle air-conditioning apparatus 100 can selectively perform an outside air heat absorbing/heating operation, a device heat recovery/heating operation, a defrosting operation, a dehumidifying operation, a cooling operation, and the like.

### <Air Conditioning Operation/Outside Air Heat Absorbing/Heating Operation>

The outside air heat absorbing/heating operation will be described with still reference to FIG. 1. Note that, in the circuits shown in FIGS. 1 to 4, the functions of the devices (configurations) that are filled in are stopped. In addition, the movement of the heat medium and the refrigerant is indicated by arrows.

In the outside air heat absorbing/heating operation, in the first heat medium circuit 5, the three-way valves 52A and 52B are switched such that the channel of the pipe 50F is closed. As a result, in the first heat medium circuit 5, the heat medium circulates through the circulation pump 51, the pipe 50A, the first heat exchanger 2 (heat medium channel 2B), the pipe 50B, the three-way valve 52B, the pipe 50C, the heater core 4, the pipe 50D, the three-way valve 52A, and the pipe 50E in this order.

In addition, in the second heat medium circuit 6, the three-way valve 62A is switched such that the channel of the pipe 60K is closed, the three-way valve 62B is switched such that the channel of the pipe 60I is closed, and the three-way valves 62C and 62D are switched such that the channel of the pipe 60J is closed. In addition, the grill shutter 71 of the external heat exchange unit 7 is opened to operate the outdoor blower 15. The heat supply device (ECH) 65 stops the operation (heat generation), but the heat medium can be circulated in the heat supply device (pipe.)

As a result, in the second heat medium circuit 6, the heat medium circulates through the circulation pump 63, the pipe 60A, the second heat exchanger 3 (heat medium channel 3B), the pipe 60B, the three-way valve 62A, the pipe 60C, the three-way valve 62B, the pipe 60D, the three-way valve 62C, the pipe 60E, the external heat exchange unit 7, the pipe 60F, the three-way valve 62D, the pipes 60G, the ECH 65, and the pipe 60H in this order.

When the outside air flows into the external heat exchange unit 7 due to traveling of the vehicle, or due to opening of the grill shutter 71 and operation of the outdoor blower 15, the heat medium flowing through the second heat medium circuit 6 absorbs heat from the outside air in the external heat exchange unit 7 and flows into the heat medium channel 3B of the second heat exchanger 3.

The heat medium exchanges heat with the refrigerant flowing through the refrigerant channel 3A of the refrigerant circuit R in the second heat exchanger 3. The heat medium of the second heat medium circuit 6 that has passed through the second heat exchanger 3 has a low temperature due to heat exchange, flows into the external heat exchange unit 7, and absorbs heat from outside air.

The refrigerant flowing through the refrigerant circuit R absorbs heat from the heat medium of the second heat medium circuit 6 in the second heat exchanger 3, and flows into the compressor 1. The refrigerant that has become high-temperature and high-pressure gas by the compressor 1 passes through the refrigerant channel 2A of the first heat exchanger 2, exchanges heat with the heat medium flowing through the heat medium channel 2B of the first heat exchanger 2, and is cooled by the heat medium to be condensed and liquefied.

When passing through the heat medium channel 2B of the first heat exchanger 2, the heat medium circulating in the first heat medium circuit 5 exchanges heat with the refrigerant, absorbs heat, and flows into the heater core 4. The heater core 4 performs heat exchange between air passing around a heat dissipation fin and a heat medium passing through a tube. The heater core 4 heats the air around the heat dissipation fin (the heat medium dissipates heat) when the heat medium heated by heat absorption is supplied. This heat exchange causes the heat medium to have a low temperature. The heat medium that has dissipated heat by the heater core 4 flows into the heat medium channel 2B of the first heat exchanger 2, exchanges heat with the refrigerant, and absorbs heat.

In the HVAC unit 10, the channel (the pipes 60K and 60I) of the heat medium flowing into the heat sink 9 from the second heat medium circuit 6 is closed, but the channel of the air passing through the heat sink 9 is secured. In addition, the air mix damper 28 is at a position to open the channel 29A and close the channel 29B, so that all the air having passed through the heat sink 9 passes through the channel 29A.

Therefore, the air introduced into the air flow passage 29 from the suction port 25 by the indoor blower 27 flows into the heater core 4 provided in the channel 29A via the heat sink 9. The air is warmed by heat exchange with the high-temperature heat medium passing through the heater core 4, and is supplied into the vehicle interior.

As described above, in the present embodiment, under the condition that the outside air heat can be absorbed, the outside air heat absorbing/heating operation is executed in which the outside air heat is absorbed by the external heat exchange unit (radiator) 7 and the vehicle interior is heated by the heat pump operation using the outside air heat as the heat absorption source of the refrigerant circuit R. Here, the “condition under which outside air heat can be absorbed” means that the frost formation state (frost formation amount) in the external heat exchange unit (radiator) 7 has not reached a level at which outside air heat absorption in the external heat exchange unit 7 becomes unfeasible. Hereinafter, this “the frost formation state (frost formation amount) is set to a level at which the external heat exchange unit 7 is unfeasible to absorb heat from the outside air” is simply referred to as an “outside air heat absorption disable level” (of frosting.)

### <Air Conditioning Operation/Device Heat Recovery/Heating Operation>

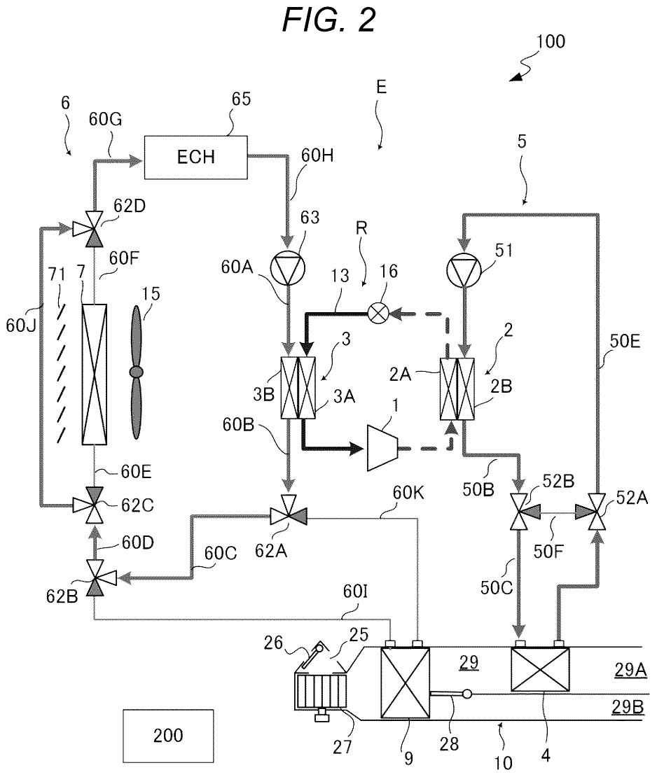

Next, the device heat recovery/heating operation will be described with reference to FIG. 2. The device heat recovery/heating operation refers to an operation in which the refrigerant circuit R absorbs heat of the heat medium heated using the heat supply device 65 to heat the heat medium. The heat supply device 65 of this example is the ECH, but is not limited to this. When there is a heat supply device such as a traveling motor or a battery (in addition to the ECH), the waste heat may be absorbed by the refrigerant circuit R as a heat absorption source to perform heating. Hereinafter, in the present embodiment, the device heat recovery/heating operation may be referred to as an “ECH heating operation” using the air conditioning circuit E of FIG. 2 as an example.

In the device heat recovery/heating operation, the configurations and the operations of the first heat medium circuit 5 and the refrigerant circuit R are similar to those of the outside air heat absorbing/heating operation, and thus the description will be omitted.

In the second heat medium circuit 6, the channel of the pipe 60K and the channel of the pipe 60I are closed similarly to the outside air heat absorbing/heating operation. On the other hand, the three-way valves 62C and 62D are switched such that the channel of the pipe 60E that serves as the inlet to the external heat exchange unit 7 and the channel of the pipe 60F that serves as the outlet from the external heat exchange unit 7 are closed and the channel of the pipe 60J is opened. As a result, the path of the heat medium passing through the external heat exchange unit 7 is bypassed by the pipe 60J. In addition, the grill shutter 71 of the external heat exchange unit 7 is closed, and the outdoor blower 15 is also stopped, while the heat supply device (ECH) 65 is operated (generates heat.)

As a result, in the second heat medium circuit 6, the heat medium circulates through the circulation pump 63, the pipe 60A, the second heat exchanger 3 (heat medium channel 3B), the pipe 60B, the three-way valve 62A, the pipe 60C, the three-way valve 62B, the pipe 60D, the three-way valve 62C, the pipe 60J, the three-way valve 62D, the pipes 60G, the ECH 65, and the pipe 60H in this order.

The ECH heating operation is performed when the frost formation on the external heat exchange unit 7 reaches the outside air heat absorption disable level and the outside air heat absorbing/heating operation is disabled. The heat medium flowing through the second heat medium circuit 6 is heated by the ECH 65 to be used as a heat absorption source of the refrigerant circuit R. That is, the heat medium having passed through the ECH 65 exchanges heat with the refrigerant of the refrigerant circuit R flowing through the refrigerant channel 3A in the second heat exchanger 3. The heat medium of the second heat medium circuit 6 that has passed through the second heat exchanger 3 has a low temperature due to heat exchange, and is heated by the ECH 65 via the pipe 60J that bypasses the external heat exchange unit 7 (absorbs heat from the ECH 65.)

The refrigerant flowing through the refrigerant circuit R absorbs heat from the heat medium of the second heat medium circuit 6 in the second heat exchanger 3, and flows into the compressor 1. The refrigerant turned into high-temperature and high-pressure gas by the compressor 1 passes through the refrigerant channel 2A of the first heat exchanger 2, exchanges heat with the heat medium flowing through the heat medium channel 2B of the first heat exchanger 2, and condenses and liquefies.

The heat medium circulating in the first heat medium circuit 5 exchanges heat with the refrigerant when passing through the first heat exchanger 2, and flows into the heater core 4. The heater core 4 heats the air around the heat dissipation fin (the heat medium dissipates heat) when the heat medium heated by heat absorption is supplied. This heat exchange causes the heat medium to have a low temperature. The heat medium that has dissipated heat by the heater core 4 flows into the heat medium channel 2B of the first heat exchanger 2, exchanges heat with the refrigerant, and absorbs heat.

In the HVAC unit 10, the air introduced into the air flow passage 29 from the suction port 25 by the indoor blower 27 flows into the heater core 4, is warmed by heat exchange with a high-temperature heat medium passing through the heater core 4, and is supplied into the vehicle interior.

In this manner, when the frost formation reaches the outside air heat absorption disable level, the heat medium that bypasses the external heat exchange unit (radiator) 7 is heated by the ECH 65. That is, heating is performed using the ECH 65 as a heat absorption source of the refrigerant circuit R. Note that, in this case, although not shown in the drawing, when there is a heat supply device (heat generation device) such as a battery or a traveling motor in the second heat medium circuit 6, by using the waste heat of the ECH 65 in addition to the ECH, it is possible to suppress the calorific value of the ECH 65 and to suppress an increase in energy consumption (power consumption amount) related to the ECH heating operation.

### <Air Conditioning Operation/Defrosting Operation (Defrosting Heating Operation)>

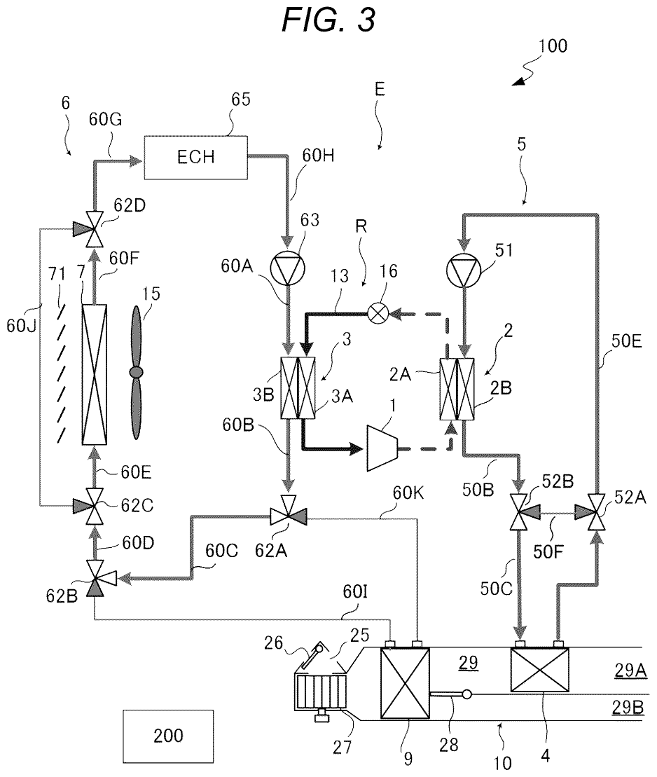

Next, a defrosting operation that defrosts the external heat exchange unit 7 will be described with reference to FIG. 3. There are various methods of defrosting the external heat exchange unit 7, for example, by routing a pipe and using the high-temperature refrigerant of the refrigerant circuit R to pass through the external heat exchange unit 7. However, in the present embodiment, as an example, a configuration is adopted in which the heat supply device (ECH) 65 of the second heat medium circuit 6 is used as a heat source for defrosting.

Since the outside air heat absorbing/heating operation is unfeasible to be executed during the defrosting, the heating operation is also executed by the ECH 65. That is, the “defrosting operation” of the present embodiment can also be said as a defrosting heating operation that combines the defrosting operation using the ECH 65 as a heat source and the ECH heating operation.

In the defrosting operation, the configurations and operations of the first heat medium circuit 5 and the refrigerant circuit R are similar to those of the outside air heat absorbing/heating operation, and thus, the description will be omitted.

The second heat medium circuit 6 has the same configuration as the device heat recovery/heating operation (ECH heating operation) shown in FIG. 2 except that the channel of the pipe 60J that bypasses the external heat exchange unit 7 is closed and the three-way valves 62C and 62D are switched so as to allow the heat medium to pass through the external heat exchange unit 7.

As a result, in the second heat medium circuit 6, the heat medium circulates through the circulation pump 63, the pipe 60A, the second heat exchanger 3 (heat medium channel 3B), the pipe 60B, the three-way valve 62A, the pipe 60C, the three-way valve 62B, the pipe 60D, the three-way valve 62C, the pipe 60E, the external heat exchange unit 7, the pipe 60F, the three-way valve 62D, the pipes 60G, the ECH 65, and the pipe 60H in this order.

The defrosting operation is a heating operation performed when the frost formation on the external heat exchange unit 7 reaches the outside air heat absorption disable level and the outside air heat absorbing/heating operation is disabled. The heat medium flowing through the second heat medium circuit 6 is heated by the ECH 65 to be used as a heat absorption source of the refrigerant circuit R. That is, the heat medium having passed through the ECH 65 exchanges heat with the refrigerant of the refrigerant circuit R flowing through the refrigerant channel 3A in the second heat exchanger 3. The heat medium of the second heat medium circuit 6 that has passed through the second heat exchanger 3 has a low temperature due to heat exchange, but its temperature is higher than the outside air. By allowing the heat medium to flow into the external heat exchange unit 7, frosting on the external heat exchange unit 7 is removed.

The refrigerant flowing through the refrigerant circuit R absorbs heat from the heat medium of the second heat medium circuit 6 in the second heat exchanger 3, and flows into the compressor 1. The refrigerant turned into high-temperature and high-pressure gas by the compressor 1 passes through the refrigerant channel 2A of the first heat exchanger 2, exchanges heat with the heat medium flowing through the heat medium channel 2B of the first heat exchanger 2, and condenses and liquefies.

The heat medium circulating in the first heat medium circuit 5 exchanges heat with the refrigerant when passing through the first heat exchanger 2, and flows into the heater core 4. The heater core 4 heats the air around the heat dissipation fin (the heat medium dissipates heat) when the heat medium heated by heat absorption is supplied. This heat exchange causes the heat medium to have a low temperature. The heat medium that has dissipated heat by the heater core 4 flows into the heat medium channel 2B of the first heat exchanger 2, exchanges heat with the refrigerant, and absorbs heat.

In the HVAC unit 10, the air introduced into the air flow passage 29 from the suction port 25 by the indoor blower 27 flows into the heater core 4, is warmed by heat exchange with a high-temperature heat medium passing through the heater core 4, and is supplied into the vehicle interior.

As described above, when the frost formation reaches the outside air heat absorption disable level, the ECH 65 is used as a heat source for defrosting and heating, and thus this enables achieving both defrosting and heating. The difference between the device heat recovery/heating operation and the defrosting operation shown in FIG. 2 is that the former is an operation in which only heating is performed without defrosting, whereas the latter is an operation in which defrosting and heating are performed. In this sense, the defrosting operation of the present embodiment can also be said as a defrosting heating operation.

In addition, although not shown in the drawing, also when there is a heat supply device (heat generation device) such as a battery or a traveling motor in the second heat medium circuit 6, by using these waste heat in addition to the ECH 65, it is possible to suppress the amount of heat generated by the ECH 65, and it is possible to suppress an increase in energy consumption (power consumption amount) related to the ECH heating operation.

### <Air Conditioning Operation/Combined Heating Operation>

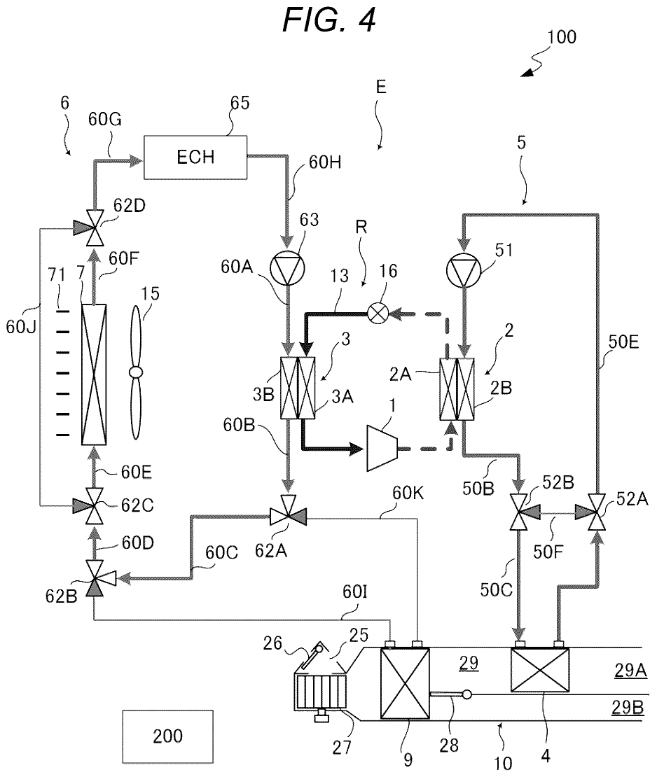

Next, a heating operation using both the outside air heat absorbing/heating operation and the device heat recovery/heating operation will be described with reference to FIG. 4.

The combined heating operation is an operation of refraining from heating by outside air heat absorption as compared with the outside air heat absorbing/heating operation shown in FIG. 1, and compensating for an insufficient temperature by heating using the ECH 65 as a heat source. The reason why such an operation is performed will be described later, but in the combined heating operation, the external heat exchange unit 7 and the heat supply device (ECH) 65 are used as heat absorption sources of the refrigerant circuit R.

In the combined heating operation, the grill shutter 71 of the external heat exchange unit 7 is opened, and the outdoor blower 15 is operated to allow outside air to flow in. Other configurations are similar to those in the defrosting operation shown in FIG. 3, and thus the description is omitted.

When the outside air flows into the external heat exchange unit 7 due to traveling of the vehicle, or due to opening of the grill shutter 71 and operation of the outdoor blower 15, the heat medium flowing through the second heat medium circuit 6 absorbs the heat from the outside air in the external heat exchange unit 7 and flows into the second heat exchanger 3. The heat medium exchanges heat with the refrigerant in the refrigerant circuit R in the second heat exchanger 3 to have a low temperature, flows into the external heat exchange unit 7, and absorbs heat from outside air.

The refrigerant flowing through the refrigerant circuit R absorbs heat from the heat medium of the second heat medium circuit 6 in the second heat exchanger 3, and flows into the compressor 1. The refrigerant turned into high-temperature and high-pressure gas by the compressor 1 passes through the first heat exchanger 2, exchanges heat with the heat medium circulating in the first heat medium circuit 5, and condenses and liquefies.

The heat medium circulating in the first heat medium circuit 5 exchanges heat with the refrigerant when passing through the first heat exchanger 2, and flows into the heater core 4. The heat medium passing through the heater core 4 heats the air passing through the periphery of the heat dissipation fin (the heat medium dissipates heat.) The heat medium that has dissipated heat by the heater core 4 flows into the heat medium channel 2B of the first heat exchanger 2, exchanges heat with the refrigerant, and absorbs heat.

In the HVAC unit 10, the air introduced into the air flow passage 29 from the suction port 25 by the indoor blower 27 flows into the heater core 4, is warmed by heat exchange with a high-temperature heat medium passing through the heater core 4, and is supplied into the vehicle interior.

As described above, in the combined heating operation, the external heat exchange unit 7 and the ECH 65 are used as heat absorption sources of the refrigerant circuit R.

In addition, when there is a heat supply device (heat generation device) such as a battery or a traveling motor in the second heat medium circuit 6 although not shown in this case, it is possible to suppress the calorific value of the ECH 65 and to suppress an increase in energy consumption (power consumption amount) related to the ECH heating operation by using the waste heat in addition to the ECH 65.

The vehicle air-conditioning apparatus 100 according to the present embodiment can perform a cooling operation and a dehumidifying operation in which the first heat exchanger 2 functions as a heat sink and the second heat exchanger 3 functions as a radiator by switching the circulation path of the refrigerant in the refrigerant circuit R by a switching valve (not shown in FIGS. 1 to 4.) However, these operations are not shown and described in detail.

### <Controller>

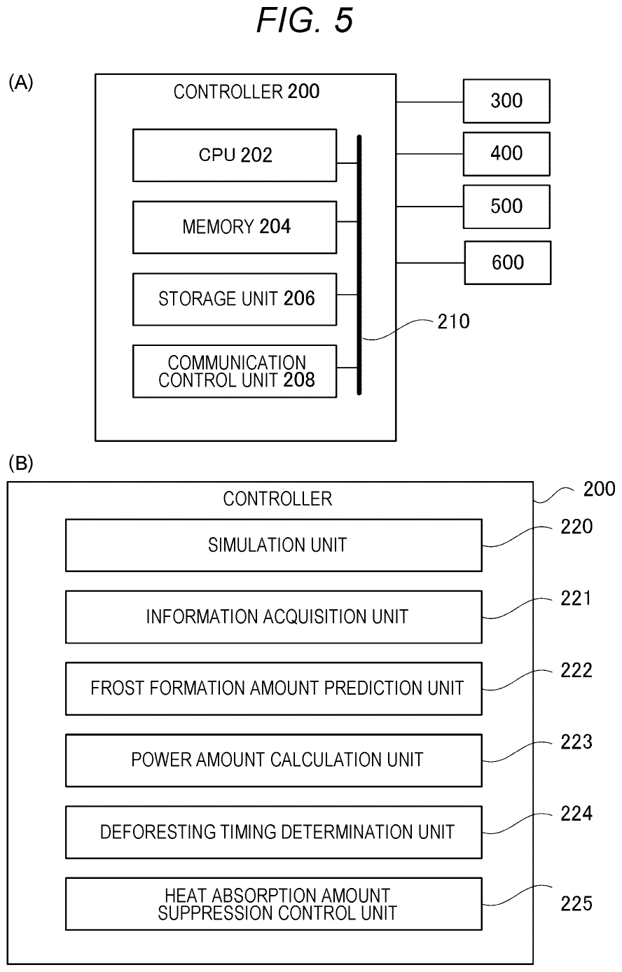

Next, the controller 200 will be described with reference to FIG. 5. FIG. 5(A) is a block diagram showing an example of a hardware configuration of the controller 200, and FIG. 5(B) is a block diagram showing an example of a functional configuration of the controller 200. In particular, FIG. 5(A) is a schematic block diagram showing an example of a functional configuration capable of executing air conditioning control in the vehicle air-conditioning apparatus 100 of the present embodiment.

As shown in FIG. 5(A), the controller 200 is achieved by an ECU (Electronic Control Unit) for air conditioning, and controls at least the refrigerant circuit R. The controller (ECU) 200 includes a central processing unit (CPU) 202, a memory 204 such as a read only memory (ROM) and a random access memory (RAM), a nonvolatile storage unit 206 such as a hard disk drive (HDD) and a solid state drive (SSD), and a communication control unit 208. The CPU 202, the memory 204, the storage unit 206, and the communication control unit 208 are communicably connected to each other via an internal bus 210.

The communication control unit 208 is connected to, for example, an ECU 300 for a vehicle that performs overall control of the vehicle including drive control of a motor for traveling and charge/discharge control of a battery, various sensors 400 including, for example, an outside air temperature sensor, a humidity sensor, a vehicle speed sensor, and the like, and (control driver) 500 for components of the air conditioning circuit E through a communication line, and can transmit and receive control signals and other information (e.g., outside air temperature, humidity, vehicle speed, and the like) to and from the ECU 300 for a vehicle, the various sensors 400, and the components of the air conditioning circuit E.

In addition, the communication control unit 208 can communicate with an external device (e.g., a server device) 600, and can transmit and receive various types of information (e.g., external information regarding the environment on the travel route, destination information, and the like) from the external device 600. Specifically, the communication control unit 208 can perform vehicle to everything (V2X) communication, for example, and can transmit and receive information between vehicles (Vehicle to Vehicle, V2V), between pedestrians (Vehicle to Pedestrian, V2P), between vehicles on roads (Vehicle to Infrastructure, V2I), and between clouds and vehicles (Vehicle to Network, V2N.)

In the present embodiment, as an example, a configuration is shown in which the communication control unit 208 of the ECU (controller 200) for air conditioning communicates with the external device 600. However, the present invention is not limited to this, and for example, a configuration may be employed in which a communication control unit (not shown) included in the vehicle ECU 300 transmits various types of information (external information, destination information, and the like) acquired by communicating with the external device 600 to the air-conditioning ECU (controller 200), and the air-conditioning ECU (controller 200) receives the various types of information.

The storage unit 206 stores a control program that executes air-conditioning control. In addition, the ECU 200 also includes a known configuration as an air-conditioning ECU, which the description will not be omitted here.

In the ECU 200, the control program is read from the storage unit 206 and developed in the memory 204, the drive control program developed in the memory 204 is executed by the CPU 202, and various functions of the air conditioning control including at least the control of the refrigerant circuit R are achieved and the air conditioning control process is executed in cooperation with each configuration (hardware) of the vehicle air-conditioning apparatus 100.

FIG. 5(B) is a schematic diagram showing an example of a functional configuration of the controller 200. The controller 200 includes, for example, a simulation unit 220, an information acquisition unit 221, a frost formation amount prediction unit 222, a power amount calculation unit 223, a defrosting timing determination unit 224, a heat absorption amount suppression control unit 225, and the like. Each of these units may be configured with a substantial component (hardware such as an electronic component (circuit or element) provided on a control board), may be configured with software (program) included in the controller 200, or may be configured with cooperation of both.

### (Simulation Unit)

The simulation unit 220 executes a simulation for a plurality of types of air conditioning operation patterns regarding future air conditioning operation from a certain point (present location) to a destination. Specifically, the vehicle air-conditioning apparatus 100 according to the present embodiment can selectively execute the outside air heat absorbing/heating operation, the device heat recovery/heating operation, the defrosting operation (defrosting heating operation), and the combined heating operation described above. In a case where the vehicle travels from a certain point (present location) to a destination, an air conditioning operation pattern combining one or more of the above operations is set along the passage of time, and the frosting state and the power consumption amount of the external heat exchange unit 7 are simulated along the air conditioning operation pattern. In addition, a plurality of types of air conditioning operation patterns is prepared and simulated to select an optimal air conditioning operation pattern. The controller 200 can execute an actual air conditioning operation along an air conditioning operation pattern selected from the plurality of air conditioning operation patterns. The plurality of types of air conditioning operation patterns will be described later.

### (Information Acquisition Unit)

The information acquisition unit 221 communicates with the external device 600 or the like via the communication control unit 208 to acquire external information on the environment on the travel route. The “external information” is, for example, road traffic information delivered to a car navigation system by a road traffic information communication system (e.g., VICS®) or the like, environmental information of a destination (outside air temperature, humidity, and the like), outside air temperature, humidity, a topographic map, map information, and the like on a travel route to the destination. In addition, the external information also includes information on the vehicle speed of the host vehicle that can be acquired via the communication control unit 208. The information acquisition unit 221 also acquires destination information. The “destination information” is information on a distance to a destination (predicted destination) and time, and is, for example, information acquired by a car navigation system or information acquired by another global positioning system (GPS), but may be information acquired from the external device 600 or the like as the external information.

The information acquisition unit 221 acquires the distance and time from the present location to the destination based on, for example, information regarding the destination input to the car navigation system. In addition, for example, in a case where the vehicle is traveling with no information regarding the destination input to the car navigation system, the information acquisition unit 221 predicts the destination from past travel history data (similar path, day of week, time, and the like), and acquires the distance and time to the predicted destination.

### (Frosting Amount Prediction Unit)

The frost formation amount prediction unit 222 predicts a frost formation state (frost formation amount) in the future (e.g., to the destination) external heat exchange unit 7 based on the destination information acquired by the information acquisition unit 221 and with reference to the external information as necessary. When the frost formation state (frost formation amount) in the external heat exchange unit 7 reaches a predetermined amount, the outside air heat absorbing/heating operation is disabled. Therefore, the frost formation amount prediction unit 222 determines whether the outside air heat absorbing/heating operation is disabled until the vehicle arrives at the destination due to the predicted future frost formation state (whether the outside air heat absorbing/heating operation can be continued to the destination.) Here, the frost formation amount (level thereof) at which the outside air heat absorbing/heating operation is disabled is referred to as an “outside air heat absorption disable level”.

Specifically, the frost formation amount prediction unit 222 predicts a change in the state of frost formation in the external heat exchange unit 7 up to the destination based on at least destination information (and external information as necessary, and so on), more specifically, a change (increase) amount (hereinafter, referred to as “frost formation variation”) of frost adhering to the external heat exchange unit between the point A and the point B. The controller 200 determines whether the defrosting operation is necessary based on the predicted frost formation variation.

In addition, when the vehicle continues to travel in the outside air heat absorbing/heating operation up to the destination, the frost formation amount prediction unit 222 calculates, based on the predicted frost formation variation, the operation time of the outside air heat absorbing/heating operation up to the point where the external heat exchange unit 7 is unfeasible to absorb the outside air heat due to the frost (the outside air heat absorbing/heating operation is disabled, that is, the frost formation amount reaches the outside air heat absorption disable level.)

The controller 200 determines whether the outside air heat absorbing/heating operation is disabled before reaching the destination based on the calculated operation time of the outside air heat absorbing/heating operation and the travel time to the destination. When the travel time to the destination is longer than the calculated operation time of the outside air heat absorbing/heating operation, the defrosting operation is executed such that at least the operation time of the outside air heat absorbing/heating operation is equal to or longer than the travel time (details will be described later.)

In addition, when the travel time to the destination is longer than the operation time of the outside air heat absorbing/heating operation, the controller 200 executes heat absorption amount suppression control that controls the air conditioning circuit such that the difference between the operation time of the outside air heat absorbing/heating operation and the travel time to the destination becomes small. The heat absorption amount suppression control will also be described later.

The frost formation amount prediction unit 222 repeatedly (intermittently) predicts the frost formation amount based on the frost formation variation at a certain timing from the start of traveling of the vehicle (the calculation of the operable time of the outside air heat absorbing/heating operation is also referred to as “frost formation amount prediction”.) The certain timing may be any timing such as when the vehicle stops traveling, in addition to a timing at a predetermined interval such as every predetermined time (e.g., five minutes) or every predetermined distance (e.g., 5 km.)

In addition, the simulation unit 220 performs a simulation for at least one air conditioning operation pattern among the plurality of types of air conditioning operation patterns at a certain timing during traveling at least once. The “certain timing during traveling” is a timing at which it is detected (predicted) that the frost formation amount reaches the outside air heat absorption disable level before the arrival at the destination by the intermittent frost formation amount prediction of the frost formation amount prediction unit 222. That is, the frost formation amount prediction unit 222 intermittently predicts the frost formation amount from the start of traveling of the vehicle, and as a result, at the timing when it is detected (predicted) that the frost formation amount reaches the outside air heat absorption disable level before the arrival at the destination, the simulation of at least one air conditioning operation pattern is executed.

As a method of predicting the frost formation amount, a known method can be employed, and as an example, there is a method of predicting the future frost formation amount by acquiring a difference between a measured value of the outlet water temperature of the coolant (heat medium) in the external heat exchange unit (radiator) 7 and a theoretical value of the outlet water temperature of the coolant at the time of no frost formation, and a correlation between the outside air temperature humidity and the frost formation variation from a previous experimental result or the like. Hereinafter, this prediction method will be briefly described.

In the calculation of a coolant outlet water temperature Tth at the time of no frost formation by Equation 1 in this case, the theoretical value of the outlet water temperature of the external heat exchange unit 7 in a case where the external heat exchange unit 7 is not frosted under the same conditions is obtained using counts k5 to k8 obtained by experiments and the like. Then, a calculation result of the coolant outlet water temperature Tth at the time of no frost formation is compared with an actual measurement value of the coolant outlet water temperature, and a present frost formation amount is estimated based on a difference between the calculation result and the actual measurement value. The larger the difference, the larger the frost formation amount.

That is, by acquiring the correlation between the magnitude of the temperature difference between the calculation result of the coolant outlet water temperature Tth at the time of no frost formation and the actual measurement value of the coolant outlet water temperature, the outside air temperature humidity, and the frost formation variation through a preliminary experiment or the like, it is possible to estimate the future frost formation amount according to the present frost formation amount, that is, the frost formation amount after a lapse of a predetermined time from the present time point.

### (Electric Energy Calculation Unit)

The power amount calculation unit 223 predicts and calculates the power consumption amount related to the air conditioning operation from a certain point (simulation start time point, present position) to a certain point in the future. The power amount calculation unit 223 is not limited to the single air conditioning operation, and can predict and calculate the total power consumption amount in a case where a plurality of air conditioning operations is mixed. Specifically, the power amount calculation unit 223 can calculate the total predicted power consumption amount for each of a plurality of types of air conditioning operation patterns obtained by combining one or more of the outside air heat absorbing/heating operation, the device heat recovery/heating operation, the defrosting operation (defrosting heating operation), and the combined heating operation. Specifically, for example, it is possible to calculate a power amount in a case where only the outside air heat absorbing/heating operation is performed, a power amount in a case where the device heat recovery/heating operation is performed without performing the defrosting operation, or a power amount in a case where the defrosting operation and the device heat recovery/heating operation are performed and the heat absorbing and heating operation is performed after the defrosting from the simulation start time point to the destination.

The power amount calculation unit 223 calculates a predicted power consumption amount related to air conditioning to the destination based on the outside air temperature of the present location, the frost formation variation calculated by the frost formation amount prediction unit 222, and the destination information. In this case, the predicted power consumption amount is calculated with reference to external information acquired as necessary.

The power amount calculation unit 223 calculates predicted power consumption amount every time when simulation is performed by the simulation unit 220. That is, when the simulation is executed a plurality of times at a plurality of points on the travel route to the destination, the predicted power consumption amount is calculated a plurality of times correspondingly.

### (Defrosting Timing Determination Unit)

When the defrosting operation is executed, the defrosting timing determination unit 224 determines the execution start timing. When defrosting is performed, the defrosting is easily affected by an external environment such as an outside air temperature, humidity, and a vehicle speed. For example, it is more efficient to perform defrosting at a relatively high point than to perform defrosting at a relatively low point of outside air temperature. The defrosting timing determination unit 224 determines a plurality of points on the travel route as candidates for the execution timing of the defrosting operation based on the external information acquired by the information acquisition unit 221.

Hereinafter, as an example, the case in which the external information is an outside air temperature on the travel route according to a weather forecast or the like will be described.

For example, when the frost formation amount reaches the outside air heat absorption disable level before arriving at the destination, the defrosting timing determination unit 224 determines, as the execution timing of the defrosting operation, a timing earlier than the arrival (immediate) of the outside air heat absorption disable level and a timing delayed from the reference (arrival) (timing of the delay execution) as candidates for the execution timing of the defrosting operation. In selecting the timing of the early execution and the timing of the delayed execution, when there is a spot where the outside air temperature is relatively higher than a spot where the outside air heat absorption disable level α reaches, the timing corresponding to the spot is selected.

The power amount calculation unit 223 calculates predicted power consumption amount in a case where the defrosting operation is performed at each of the plurality of candidate execution times. When the defrosting operation is executed by selecting one of the execution timings that are candidates, the controller 200 (defrosting timing determination unit 224) makes determination such that to start defrosting operation is started at the execution timing at which the predicted power consumption amount is minimized.

Note that the execution timing of the defrosting operation is not limited to selecting early execution and delayed execution as candidates based on the time when the outside air heat absorption disable level α is reached. For example, a period corresponding to a plurality of arbitrary points (points where predicted power consumption is likely to be small) on the travel route from the present point to the destination may be selected as the start period (candidate) of the defrosting operation, and the defrosting operation may be executed at a point where the predicted power consumption is minimum among the points. The arbitrary plurality of points may be selected based on, for example, various information such as outside air temperature, humidity, traffic information, topography, whether the place is an urban area or a suburb, and the like.

The defrosting timing determination unit 224 also determines a defrosting period to be actually executed by the controller 200 from a result of simulation performed by the simulation unit 220 based on the selected defrosting operation execution period candidate.

### (Heat Absorption Amount Suppression Control Unit)

The heat absorption amount suppression control unit 225 performs adjustment control such that the performance of the outside air heat absorbing/heating operation can be utilized at the maximum, that is, in the vicinity of the destination, of adjusting the frost formation amount exceeds a certain level and reaches an outside air heat absorption disable level or becomes much closer to the outside air heat absorption disable level.

For example, the frost formation amount prediction unit 222 calculates the travel time to the destination and the time until the external heat exchange unit 7 is unfeasible to absorb heat of the outside air (the operation time of the outside air heat absorbing/heating operation), and when it is determined that the travel time to the destination is longer than the operation time of the outside air heat absorbing/heating operation (the defrosting operation is necessary), the heat absorption amount suppression control unit 225 executes the heat absorption amount suppression control that controls the air conditioning circuit such that the difference between the operation time and the travel time of the outside air heat absorbing/heating operation is reduced.

In general, it is advantageous in terms of power consumption amount when the vehicle can reach the destination only by the outside air heat absorbing/heating operation. However, the defrosting operation may be necessary because the distance to the destination is long or the outside air temperature is low. Even in this case, desirably, the frost formation amount reaches the outside air heat absorption disable level or approaches the outside air heat absorption disable level in the vicinity of the destination because the performance of the outside air heat absorbing/heating operation can be utilized at the maximum.

When the frost formation amount at destination arrival time is predicted to exceed the outside air heat absorption disable level, the heat absorption amount suppression control unit 225 suppresses the operation time and the heating performance (outside air heat absorption amount) of the outside air heat absorbing/heating operation such that the frost formation amount at destination arrival time reaches, for example, 50% or more of the outside air heat absorption disable level without executing the defrosting operation. By suppressing the outside air heat absorption amount in the outside air heat absorbing/heating operation, as a result, the frost formation amount of the external heat exchange unit 7 is suppressed.

The heat absorption amount suppression control unit 225 also reduces the temperature of the heater core 4 in the HVAC unit 10 by suppressing the outside air heat absorption amount, so that the heat absorption amount suppression control unit 225 reduces the air quantity of the indoor blower 27 to minimize the reduction in the blowing temperature.

The air conditioning comfort in the vehicle is slightly sacrificed by the suppression of the heating performance of the outside air heat absorbing/heating operation. Therefore, in order to compensate for the heating performance of the sacrificed outside air heat absorbing/heating operation, the heat absorption amount suppression control unit 225 can also perform control of suppressing the temperature decrease in the vehicle interior by performing the ECH heating operation in an auxiliary manner.

In addition to the control by the heat absorption amount suppression control unit 225, the controller 200 performs the air conditioning operation such that the performance of the outside air heat absorbing/heating operation can be utilized at the maximum. For example, even when the defrosting operation is executed, the defrosting operation (defrosting amount and time of defrosting operation) and the subsequent outside air heat absorbing/heating operation (operation time) can be controlled such that the frost formation amount at destination arrival time reaches 50% or more of the heat absorption disable level.

As described above, the controller 200 according to the present embodiment includes the simulation unit 220 that predicts a future frost formation amount and predicts a power (power consumption) amount related to air conditioning, and thus the controller 200 simulates, with the simulation unit 220, the frost formation amount and the power consumption amount for a plurality of types of air conditioning operation patterns assumed in advance.

The controller 200 compares the predicted power consumption calculated as a result of the simulation of at least two air conditioning operation patterns, selects an air conditioning operation pattern with the minimum predicted power consumption, and executes the air conditioning operation to the destination. As a result, for example, it is possible to appropriately select and perform an efficient air conditioning operation according to destination information and external information such as which of the device heat recovery/heating operation and the defrosting operation is selected from the simulation start time point (present time point) to the destination, the outside air heat absorbing/heating operation is performed after the defrosting operation is performed, or whether the defrosting operation is immediately started in a case where the defrosting operation is necessary before reaching the destination (in a case where the frost formation amount reaches the outside air heat absorption disable level), and it is possible to suppress a decrease in the cruising distance by the energy saving effect.

Note that, in the present embodiment, for convenience of description, the functions of the controller 200 have been described by being divided into the configurations shown in FIG. 5(B), but these are merely examples, and the configuration (components) that achieves each function in the controller 200 is not limited to the above examples. In addition, the components that achieve the above functions are unnecessarily the components that are divided into blocks (unitized) as shown in FIG. 5(B) and that share the functions. For example, the controller 200 may have configuration that achieves an information acquisition function, a frost formation amount prediction function, a power amount calculation function, a defrosting time determination function, a heat absorption amount suppression control function, a simulation function, and the like as a whole.

### <Air Conditioning Operation Pattern>

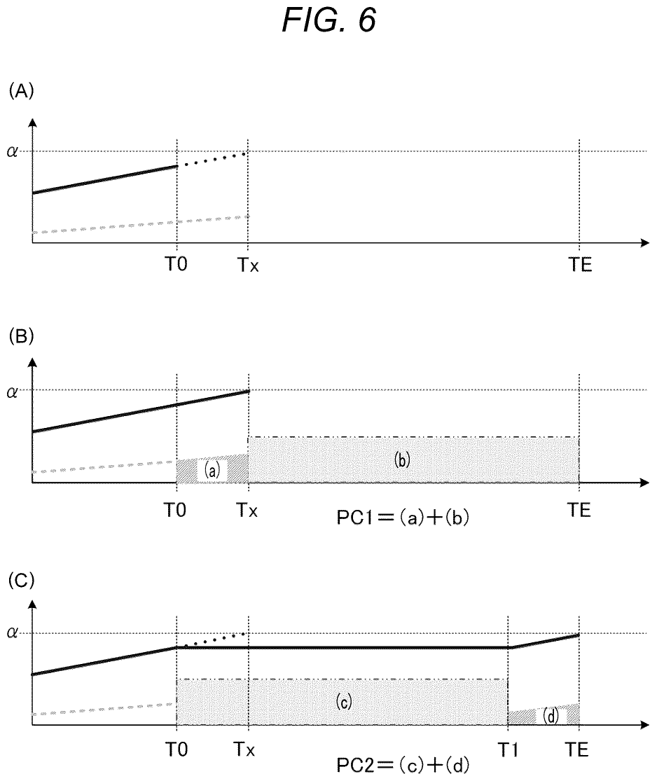

Next, an example of an air conditioning operation pattern will be described with reference to FIGS. 6 to 12. In addition to the control (operation) described above, the controller 200 can execute control (operation) of achieving the following simulation of the air conditioning operation pattern.

In the graphs shown in FIGS. 6 to 10, the horizontal axis represents time, and the vertical axis represents the frost formation amount (actual measurement and prediction) and the power consumption amount (actual measurement, prediction.) The frost formation amount and the power consumption amount are actual measurement values until present time T0, and are prediction values after present time T0. The frost formation amount is indicated by a thick line, and the power consumption amount is indicated by a broken line and filled areas. In addition, a on the vertical axis indicates an outside air heat absorption disable level of the frost formation amount.

First, FIG. 6(A) is a graph showing an example of a state of the air conditioning operation at a certain time point during traveling. In this case, the frost formation amount is close to the outside air heat absorption disable level α at present time T0, and it is the timing when it is detected (predicted) that the frost formation amount reaches the outside air heat absorption disable level α at time Tx before destination estimated time TE, that is, it is detected (predicted) that the frost formation amount reaches the outside air heat absorption disable level α before the arrival at the destination (at time Tx) as indicated by a dotted line when the traveling is continued as it is by the intermittent prediction of the frost formation amount prediction unit 222. “The frost formation amount reaching the outside air heat absorption disable level α” means that defrosting is necessary before the vehicle reaches the destination when the vehicle continues to travel as it is. Hereinafter, detection of “the frost formation amount reaching the outside air heat absorption disable level α” may be referred to as detection of “defrosting necessary”.

The simulation unit 220 according to the present embodiment executes a simulation of one or a plurality of air conditioning operation patterns described below in response to detection of defrosting necessary as shown in FIG. 6(A.)

### <Air Conditioning Operation Pattern 1>

FIG. 6(B) shows an air conditioning operation pattern 1. The air conditioning operation pattern 1 is a pattern in which the outside air heat absorbing/heating operation (FIG. 1) is performed from present time T0 to time Tx when the outside air heat absorption disable level α is reached, the defrosting operation is not performed after time Tx when the outside air heat absorption disable level α is reached, and the device heat recovery/heating operation (ECH heating operation) shown in FIG. 2 is performed to the destination. When the outside air heat absorption disable level α is reached, the outside air heat absorbing/heating operation is disabled, and thus the device heat recovery/heating operation is executed instead. This is a pattern that can simulate how much power consumption amount is generated in this case.

In this case, as total predicted power consumption PC1 from present time T0 to predicted destination arrival time TE, the power amount calculation unit 223 calculates a total value (PC1=(a)+(b)) of the predicted power consumption amount (a) of the outside air heat absorbing/heating operation from present time T0 to outside air heat absorption disable level arrival time Tx and the predicted power consumption amount (b) of the ECH heating operation from outside air heat absorption disable level arrival time Tx to predicted destination arrival time TE.

### <Air Conditioning Operation Pattern 2>

FIG. 6(C) shows an air conditioning operation pattern 2. In the air conditioning operation pattern 2, the state at present time T0 is similar to that in FIG. 6(B). That is, in FIG. 6(C), the defrosting operation is necessary until the vehicle reaches the destination, but the outside air heat absorbing/heating operation is still possible at present time T0. In the air conditioning operation pattern 2, it is determined that the immediate defrosting operation is unnecessary at present time T0, and the outside air heat absorbing/heating operation is stopped. IN addition, the defrosting operation is not performed, and the operation is switched to the device heat recovery/heating operation (ECH heating operation, FIG. 3). Then, the outside air heat absorbing/heating operation (FIG. 1) with reserve power (the frost formation amount does not reach the outside air heat absorption disable level α) is executed near the destination.

As described above, the air conditioning operation pattern 2 is a pattern in which the device heat recovery/heating operation is executed when it is determined that the defrosting operation is necessary until the vehicle reaches the destination but the immediate execution is unnecessary, and the operation is switched to the outside air heat absorbing/heating operation when the vehicle comes near the destination. Similarly to the air conditioning operation pattern 1, the air conditioning operation pattern 2 is a pattern in which it is possible to simulate how much power consumption amount is generated when the device heat recovery/heating operation is executed instead of the outside air heat absorbing/heating operation.

In this case, desirably, the level of the frost formation amount reaches the vicinity of the outside air heat absorption disable level α at the destination. That is, based on the frost formation amount change rate (proportional to time) predicted by the frost formation amount prediction unit 222, the controller 200 (e.g., the simulation unit 220) performs back calculation on the assumption that the level of the frost formation amount reaches the vicinity of the outside air heat absorption disable level α at the destination, and determines time T1 at which the outside air heat absorbing/heating operation is started near the destination. Here, “the level of the frost formation amount reaching the vicinity of the outside air heat absorption disable level α at the destination” means that the level of the frost formation amount reaches 50% or more of the outside air heat absorption disable level α at the destination. Preferably, the level of the frost formation amount reaches about 70% to 100% of the outside air heat absorption disable level α. More preferably, the level of the frost formation amount reaches about 90% to 100% of the outside air heat absorption disable level α.

As described above, switching to outside air heat absorption near the destination enables reduction in power consumption as compared with the case in which the ECH heating operation is continued up to the destination (e.g., air conditioning operation pattern 1.)

In this case, as total predicted power consumption PC2 from present time T0 to predicted destination arrival time TE, the power amount calculation unit 223 calculates a total value (PC2=(c)+(d)) of the predicted power consumption amount (c) of the ECH heating operation from present time T0 to time T1 and the predicted power consumption amount (d) of the outside air heat absorbing/heating operation from time T1 to predicted destination arrival time TE.

### <Air Conditioning Operation Pattern 3>

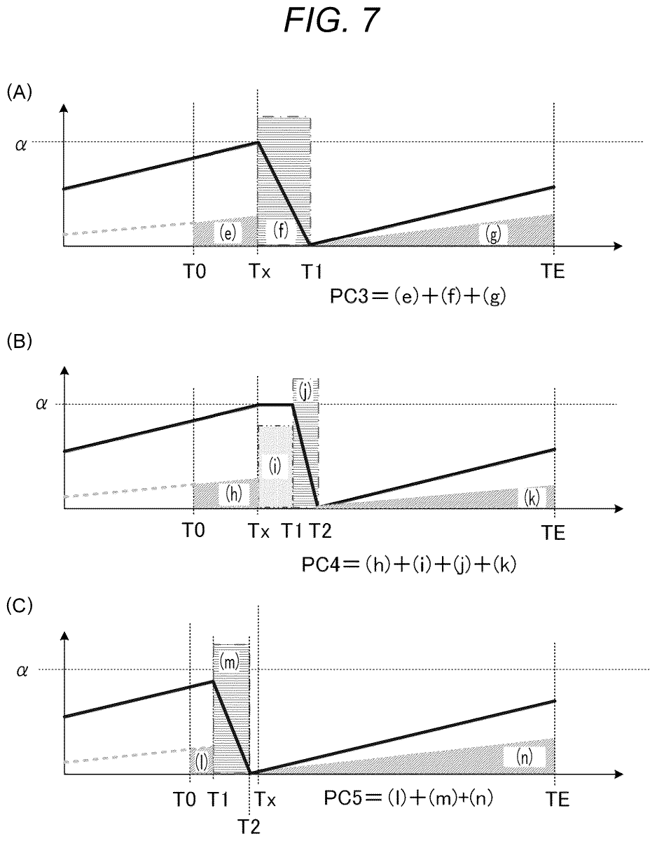

FIG. 7(A) shows an air conditioning operation pattern 3. The air conditioning operation pattern 3 is a pattern in which the outside air heat absorbing/heating operation (FIG. 1) is executed until the outside air heat absorption disable level α is reached after present time T0 (until outside air heat absorption disable level arrival time Tx), the defrosting operation (defrosting heating operation) shown in FIG. 3 is executed from outside air heat absorption disable level arrival time Tx (immediately), and the outside air heat absorbing/heating operation (FIG. 1) is executed from time T1 when the defrosting is completed (substantially all the frosting is removed) to the destination.

As described above, the defrosting operation is an air conditioning operation using both the defrosting operation using the ECH 65 as a heat source and the ECH heating operation. When the frost formation reaches the outside air heat absorption disable level α, the outside air heat absorbing/heating operation is disabled. Therefore, the ECH heating operation is performed instead, and the defrosting operation is performed using the ECH 65 as a heat source, so that both the heating operation and the defrosting operation can be performed. The air conditioning operation pattern 3 is a pattern that can simulate how much power consumption amount is generated when defrosting is performed and the outside air heat absorbing/heating operation is resumed, instead of replacing the frost formation by the device heat recovery/heating operation when the outside air heat absorbing/heating operation is unfeasible.

In this case, as total predicted power consumption PC3 from present time T0 to predicted destination arrival time TE, the power amount calculation unit 223 calculates a total value (PC3=(e)+(f)+(g)) of the predicted power consumption amount (e) of the outside air heat absorbing/heating operation from present time T0 to outside air heat absorption disable level arrival time Tx, the predicted power consumption amount (f) of the defrosting operation from outside air heat absorption disable level arrival time Tx to time T1 in a case where the defrosting is completed, and the predicted power consumption amount (g) of the outside air heat absorbing/heating operation from time T1 to predicted destination arrival time TE.

### <Air Conditioning Operation Pattern 4>

FIG. 7(B) shows an air conditioning operation pattern 4. In the air conditioning operation pattern 4, the outside air heat absorbing/heating operation (FIG. 1) is executed until the heat absorption disable level α is reached after present time T0 (until outside air heat absorption disable level arrival time Tx), the defrosting operation is not immediately executed from outside air heat absorption disable level arrival time Tx, and the device heat recovery/heating operation (FIG. 2) is executed until time T1. This is a pattern in which the defrosting operation (FIG. 3) is executed from time T1, and the outside air heat absorbing/heating operation is executed from time T2 when the defrosting is completed (substantially all the frosting is removed) to the destination. The air conditioning operation pattern 4 is also similar to the air conditioning operation pattern 3, but is a pattern that can simulate how much power consumption amount is generated when the start timing of the defrosting operation is varied.

The start time T1 of the defrosting operation in this case is the time of delay execution of the defrosting operation determined (selected) by the defrosting timing determination unit 224. Based on the external information on the travel route, the defrosting timing determination unit 224 determines time T1 as a timing (delay execution) delayed from outside air heat absorption disable level arrival time Tx as a timing (there is a possibility) at which the defrosting can be efficiently performed.

In the simulation of the air conditioning operation pattern 4, based on this, the defrosting operation is not immediately executed from outside air heat absorption disable level arrival time Tx, and the defrosting operation is on standby until time T1 of the delay execution.

In this case, for example, as compared with the case of FIG. 7A, there is a possibility that the predicted power consumption amount related to the defrosting operation can be reduced.

In this case, as total predicted power consumption PC4 from present time T0 to predicted destination arrival time TE, the power amount calculation unit 223 calculates a total value (PC4=(h)+(i)+(j)+(k)) of the predicted power consumption amount (h) of the outside air heat absorbing/heating operation from present time T0 to outside air heat absorption disable level arrival time Tx, the predicted power consumption amount (i) of the device heat recovery/heating operation from outside air heat absorption disable level arrival time Tx to time T1 at which the defrosting operation stands by, the predicted power consumption amount (j) of the defrosting operation from time T1 to time T2 at which the defrosting is started and completed, and the predicted power consumption amount (k) of the outside air heat absorbing/heating operation from time T2 at which the defrosting is completed to destination arrival time TE.

### <Air Conditioning Operation Pattern 5>

FIG. 7(C) shows an air conditioning operation pattern 5. In the air conditioning operation pattern 5, the outside air heat absorbing/heating operation (FIG. 1) is executed after present time T0, but the outside air heat absorbing/heating operation is stopped at time T1 earlier than reaching the outside air heat absorption disable level α to switch to the defrosting operation (FIG. 3.) This is a pattern in which the outside air heat absorbing/heating operation is executed from time T2 when the defrosting is completed (substantially all the frosting is removed) to the destination. The air conditioning operation pattern 5 is also similar to the air conditioning operation pattern 3, but is a pattern that can simulate how much power consumption amount is generated when the start timing of the defrosting operation is varied from those of the air conditioning operation patterns 3 and 4.

The start time T1 of the defrosting operation in this case is a time for early execution of the defrosting operation determined (selected) by the defrosting timing determination unit 224. Based on the external information on the travel route, the defrosting timing determination unit 224 determines time T1 as a timing (early execution) earlier than outside air heat absorption disable level arrival time Tx as a timing at which the defrosting can be efficiently performed (there is a possibility.)

In this case, as total predicted power consumption PC5 from present time T0 to predicted destination arrival time TE, the power amount calculation unit 223 calculates a total value (PC5=(l)+(m)+(n)) of the predicted power consumption amount (l) of the outside air heat absorbing/heating operation from present time T0 to time T1, the predicted power consumption amount (m) of the defrosting operation from time T1 to time T2 at which the defrosting operation is started and the defrosting is completed, and the predicted power consumption amount (n) of the outside air heat absorbing/heating operation from time T2 at which the defrosting is completed to predicted destination arrival time TE.

The air conditioning operation patterns 3 to 5 are a pattern in which, when it is determined that the defrosting operation is necessary before the vehicle reaches the destination, the operation shifts to the outside air heat absorbing/heating operation after the defrosting operation is executed.

### <Air Conditioning Operation Pattern 6>

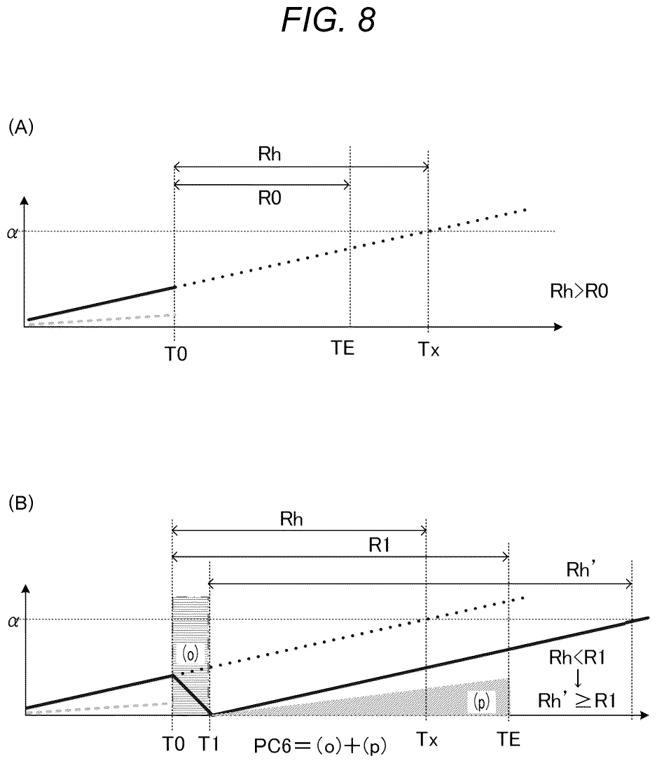

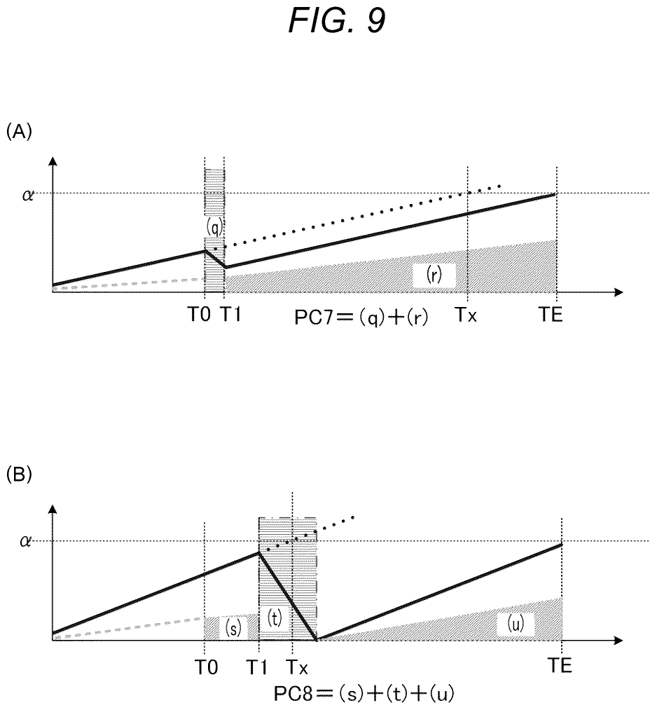

An air conditioning operation pattern 6 will be described with reference to FIG. 8. First, FIG. 8(A) shows a state in which the frost formation amount is relatively small, that is, the progress of the frost formation does not advance at a time point at which the necessity of the defrosting operation is determined (a time point at which “defrosting necessary” is detected by the frost formation amount prediction based on the frost formation variation.) When the defrosting operation is performed before the arrival at the destination in a case where the progress of the frost formation is slow as described above, there is a possibility that the vehicle arrives at the destination in a state where (large) reserve power of the outside air heat absorbing/heating operation remains, and there is a possibility that energy related to the defrosting operation is wastefully consumed.

Therefore, in the air conditioning operation pattern 6, a time parameter is also adopted for detection of “defrosting necessary”. That is, the controller 200 (frost formation amount prediction unit 222) detects the frost formation amount at intermittent timings, and performs prediction indicated by a dotted line in FIG. 8(A). The controller 200 (frost formation amount prediction unit 222) also calculates travel time R0 from the present location to the destination (time from present time T0 to predicted destination arrival time TE), and time (outside air heat absorbing/heating executable time) Rh of the outside air heat absorbing/heating operation (FIG. 1) from present time T0 until outside air heat absorption becomes unfeasible in the external heat exchange unit 7 due to frosting (until outside air heat absorption disable level arrival time Tx.)

When travel time R0 is longer than outside air heat absorbing/heating executable time Rh, it is determined (detected) as “defrosting necessary (time)”.

For example, in this determination, as shown in FIG. 8(A), when the distance to the destination is short (travel time R0<outside air heat absorbing/heating executable time Rh), defrosting is not performed.

On the other hand, when “defrosting necessary (time)” is detected, the defrosting operation is executed in a stage far from the destination (immediately after detection of “defrosting necessary (time)”.) As a result, since the outside air heat absorbing/heating operation can be executed to the destination after the defrosting operation, it is possible to reduce the possibility that the performance of the outside air heat absorbing/heating operation is wasted in the vicinity of the destination (at the end of traveling).

FIG. 8(B) is a graph showing air conditioning operation pattern 6, and shows a state in which “defrosting necessary (time)” is detected as a result of predicting the frost formation amount with parameters including such time. In the case of the frost formation amount (predicted amount) indicated by a dotted line in FIG. 8(B), the calculated travel time R1 from the present location to the destination (time from present time T0 to predicted destination arrival time TE) is compared with outside air heat absorbing/heating executable time Rh, and R1>Rh, which is “defrosting necessary (time)”.

In this case, the defrosting operation is executed in a stage far from the destination (preferably, immediately after detection of “defrosting necessary (time)”), and then the outside air heat absorbing/heating operation is executed to adjust the outside air heat absorbing/heating executable time (obtain a new outside air heat absorbing/heating executable time Rh′.) That is, the execution time of the defrosting operation is a time (Rh′>R1) during which new outside air heat absorbing/heating executable time Rh′ (after completion of defrosting) becomes equal to or longer than travel time R1.

By performing the necessary defrosting operation first (immediately after the detection of “defrosting necessary (time)”, the outside air heat absorbing/heating operation can be performed up to the destination after the defrosting operation. Therefore, it is possible to reduce the possibility that the performance of the outside air heat absorbing/heating operation is wasted in the vicinity of the destination (at the end of traveling).

In addition, since the defrosting operation is performed in a stage where the progress of the frosting is small, it is also possible to reduce the power consumption related to the defrosting operation.

Further, the frost formation amount (predicted amount) according to the present embodiment is a value based on the frost formation variation calculated by the frost formation amount prediction unit 222 based on the destination information (and external information as necessary, and so on). That is, the accuracy of outside air heat absorbing/heating executable times Rh and Rh′ can be improved by calculating the outside air heat absorbing/heating executable times Rh and Rh′ based on the frost formation variation. As a result, it is possible to select the necessity of the appropriate defrosting operation, and it is possible to minimize the waste of power consumption due to the defrosting operation (the same applies to air conditioning operation patterns 7 and 8).

Specifically, the air conditioning operation pattern 6 is a pattern in which the defrosting operation is immediately started at present time T0 when the frost formation is relatively small, and the outside air heat absorbing/heating operation is executed from time T1 when the defrosting is completed (substantially all the frost formation is removed) to the destination.

In this case, as total predicted power consumption PC6 from present time T0 to predicted destination arrival time TE, the power amount calculation unit 223 calculates a total value (PC6=(o)+(p)) of the predicted power consumption amount (o) of the defrosting operation from present time T0 to time T1 and the predicted power consumption amount (p) of the outside air heat absorbing/heating operation from time T1 to predicted destination arrival time TE.

### <Air Conditioning Operation Pattern 7>

FIG. 9(A) shows an air conditioning operation pattern 7. The air conditioning operation pattern 7 is also a pattern in which the defrosting operation is performed after the detection of “defrosting necessary (time)”, but the defrosting is not almost completely performed during the defrosting operation (FIG. 3) in the air conditioning operation pattern 7, and only a part of the frosting is removed. In addition, the defrosting amount is controlled such that the frost formation amount at predicted destination arrival time TE reaches 50% or more of the outside air heat absorption disable level α (approach closer to the heat absorption disable level α, or reach the heat absorption disable level α), and the defrosting operation time (that is, the start time of the outside air heat absorbing/heating operation after defrosting) is controlled. Even when the frost formation on the radiator 7 is not completely (almost completely) removed, the outside air heat absorbing/heating operation (FIG. 1) can be performed up to the destination. Further, since the operation can be performed such that the frost formation amount at predicted destination arrival time TE reaches 50% or more of the outside air heat absorption disable level (reach or come closer to heat absorption disable level α), the traveling can be always ended in the state of the outside air heat absorbing/heating operation.

In the air conditioning operation pattern 7, the defrosting amount and the time of the defrosting operation are controlled such that the level of the frost formation amount reaches 50% or more of the outside air heat absorption disable level α, preferably about 70% to 100% of the outside air heat absorption disable level α, more preferably about 90% to 100% of the outside air heat absorption disable level α. Since the operable time of the outside air heat absorbing/heating operation with high system efficiency can be substantially used up to the end of traveling, it is possible to suppress an increase in consumed energy (the same applies to the air conditioning operation pattern 8.)

In this case, as total predicted power consumption PC7 from present time T0 to predicted destination arrival time TE, the power amount calculation unit 223 calculates a total value (PC7=(q)+(r)) of the predicted power consumption amount (q) of the defrosting operation from present time T0 to time T1 and the predicted power consumption amount (r) of the outside air heat absorbing/heating operation from time T1 to predicted destination arrival time TE.

<Air conditioning operation pattern 8>

FIG. 9(B) shows an air conditioning operation pattern 8. The air conditioning operation pattern 8 is a pattern that controls the defrosting time (and the defrosting amount) and controls the start time of the outside air heat absorbing/heating operation (FIG. 1) after the defrosting such that the frost formation amount at predicted destination arrival time TE reaches 50% or more of the outside air heat absorption disable level (reach or come closer to heat absorption disable level α) in the air conditioning operation pattern 5 shown in FIG. 7(C). This pattern can also be said as an early execution of the defrosting operation (air conditioning operation pattern 5), but is different in that the frost formation amount at predicted destination arrival time TE is controlled to reach 50% or more of the outside air heat absorption disable level.

Although the air conditioning operation pattern 8 of FIG. 9(B) shows an example in which all (almost completely) the frost formation on the radiator 7 is removed, the defrosting amount may be a part of the defrosting amount as shown in FIG. 9(A) as long as the outside air heat absorbing/heating operation is performed such that the frost formation amount at predicted destination arrival time TE reaches 50% or more of the heat absorption disable level.

In this case, as total predicted power consumption PC8 from present time T0 to predicted destination arrival time TE, the power amount calculation unit 223 calculates a total value (PC8=(s)+(t)+(u)) of the predicted power consumption amount(s) of the outside air heat absorbing/heating operation from present time T0 to time T1, the predicted power consumption amount (t) of the defrosting operation from time T1 to time T2 at which the defrosting operation is performed and the defrosting is completed, and the predicted power consumption amount (u) of the outside air heat absorbing/heating operation from time T2 to predicted destination arrival time TE.

### <Air Conditioning Operation Pattern 9>

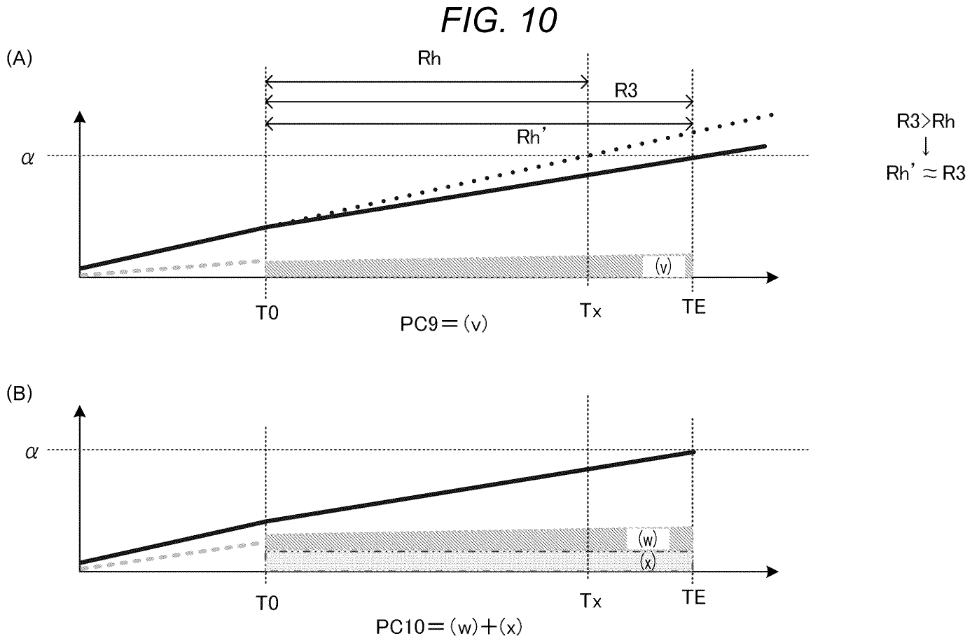

FIG. 10(A) shows an air conditioning operation pattern 9. The air conditioning operation pattern 9 also determines whether the defrosting operation is necessary, including time parameters, similarly to the air conditioning operation pattern 6. In the case of FIG. 10(A), “defrosting necessary (time)” is detected (predicted) at present time T0. The air conditioning operation pattern 9 is a pattern in which, even when “defrosting necessary (time)” is detected, the vehicle arrives at the destination only by the outside air heat absorbing/heating operation without performing the defrosting operation.

Here, detection of “defrosting necessary” in air conditioning operation patterns 9 and 10 will be described below. Also in the air conditioning operation patterns 9 and 10, time parameters are adopted for detection of “defrosting necessary”. That is, the controller 200 (frost formation amount prediction unit 222) detects the frost formation amount at intermittent timings, and performs prediction indicated by a dotted line in FIG. 10(A). The controller 200 (frost formation amount prediction unit 222) also calculates travel time R3 from the present location to the destination (time from present time T0 to predicted destination arrival time TE) and outside air heat absorbing/heating executable time Rh, and determines (detects) that “defrosting necessary (time)” in a case where travel time R3 is longer than outside air heat absorbing/heating executable time Rh.

In the case of the frost formation amount (prediction amount) indicated by a dotted line in FIG. 10(A), R3>Rh, and “defrosting necessary (time)”. In the air conditioning operation pattern 9, when “defrosting necessary (time)” is detected, the heat absorption amount suppression control is performed, the control (operation state) of the outside air heat absorbing/heating operation is changed, and the outside air heat absorbing/heating executable time is adjusted (new outside air heat absorbing/heating executable time Rh′ is obtained). Specifically, the heat absorption amount suppression control executes the heat absorption amount suppression control such that a difference between travel time R3 to the destination and outside air heat absorbing/heating executable time Rh′ becomes small (desirably, travel time R3 and outside air heat absorbing/heating executable time Rh′ become substantially equal). Note that the frost formation amounts (predicted amounts) at and after present time T0 are values based on the frost formation variations calculated by the frost formation amount prediction unit 222 based on the destination information. By calculating outside air heat absorbing/heating executable times Rh and Rh′ based on the frost formation variations, it is possible to improve accuracy of the outside air heat absorbing/heating executable times Rh and Rh′ (the same applies to the air conditioning operation pattern 10).

In the air conditioning operation pattern 9, at destination arrival time, the outside air heat absorbing/heating operation is disabled or in a state close to disable (the heat absorption amount and the frost formation amount are controlled to obtain this state), so that the traveling can be always ended by the outside air heat absorbing/heating operation with high system efficiency. As a result, it is possible to suppress an increase in energy consumed by the vehicle air-conditioning apparatus 100.

Since “defrosting necessary (time)” is detected in the air conditioning operation pattern 9, heat absorption amount suppression control is performed such that a difference between travel time R3 and outside air heat absorbing/heating executable time Rh′ is reduced. The small difference between travel time R3 and outside air heat absorbing/heating executable time Rh′ means that the frost formation amount at predicted destination arrival time TE approaches the outside air heat absorption disable level α. When travel time R3 is equal to outside air heat absorbing/heating executable time Rh′, the frost formation amount at predicted destination arrival time TE is substantially equal to the outside air heat absorption disable level α (FIG. 10(A)). In the air conditioning operation pattern 9, the heat absorption amount suppression control is performed such that the difference between travel time R3 and outside air heat absorbing/heating executable time Rh′ becomes small. This means that the heating performance of the outside air heat absorbing/heating operation is suppressed after present time T0, and the outside air heat absorbing/heating operation is performed such that the frost formation amount at predicted destination arrival time TE reaches 50% or more of the heat absorption disable level α.

In the air conditioning operation pattern 9, the heat absorption amount suppression control is performed such that the frost formation amount at predicted destination arrival time TE reaches 50% or more of the outside air heat absorption disable level α, preferably the level of the frost formation amount reaches about 70% to 100% of the outside air heat absorption disable level α, more preferably the level of the frost formation amount reaches about 90% to 100% of the outside air heat absorption disable level α. Since the operable time of the outside air heat absorbing/heating operation with high system efficiency can be substantially used up to the end of traveling, it is possible to suppress an increase in consumed energy (the same applies to the air conditioning operation pattern 10).

The heat absorption amount suppression control is control of suppressing heating performance in the outside air heat absorbing/heating operation. Specifically, in order to suppress operation time and heating performance (outside air heat absorption amount) of the outside air heat absorbing/heating operation, for example, the heat absorption amount suppression control weakens or stops the air blowing quantity of the outdoor blower 15 in order to lower the temperature of the heater core 4 in the HVAC unit 10 or to suppress the inflow amount of outside air. In addition, since the heat absorption amount decreases, the heat absorption amount suppression control unit 225 decreases the air quantity of the indoor blower 27 to minimize the decrease in the blowing temperature.

In this case, as total predicted power consumption PC9 from present time T0 to predicted destination arrival time TE, the power amount calculation unit 223 calculates the predicted power consumption amount (v) of the suppressed outside air heat absorbing/heating operation from present time T0 to predicted destination arrival time TE.

### <Air Conditioning Operation Pattern 10>

FIG. 10(B) shows an air conditioning operation pattern 10. In the air conditioning operation pattern 9, the air conditioning comfort in the vehicle is slightly sacrificed by the suppression of the heating performance of the outside air heat absorbing/heating operation. Therefore, in the air conditioning operation pattern 10, in order to supplement the heating performance of the sacrificed outside air heat absorbing/heating operation, the device heat recovery/heating operation (ECH heating operation) is supplementarily performed to suppress a temperature decrease in the vehicle interior. That is, in this case, the combined heating operation shown in FIG. 4 is performed. The outside air heat absorbing/heating operation is controlled such that the frost formation amount at predicted destination arrival time TE reaches 50% or more of the outside air heat absorption disable level (reach or come closer to heat absorption disable level α) while suppressing the outside air heat absorption amount.

In this case, as total predicted power consumption PC10 from present time T0 to predicted destination arrival time TE, the power amount calculation unit 223 calculates a total value (PC10=(w)+(x)) of the predicted power consumption amount (w) of the outside air heat absorbing/heating operation suppressed from present time T0 to predicted destination arrival time TE and the predicted power consumption amount (x) of the device heat recovery/heating operation.

By such a simulation, it is possible to grasp a plurality of air conditioning operation patterns in a case where the outside air heat absorbing/heating operation becomes unfeasible due to frosting. By comparing these patterns, the air conditioning operation can be performed with the best air conditioning operation pattern according to the destination or the real-time surrounding environment. Specifically, the following cases can be grasped and compared, and the air conditioning operation can be executed.

(1) Selection of the Device Heat Recovery/Heating Operation and the Defrosting Operation (Subsequent Outside Air Heat Absorbing/Heating Operation) in a Case where the Outside Air Heat Absorbing/Heating Operation is Disabled.

In this case, for example, the predicted power consumption amount of the air conditioning operation patterns 1 to 5 are compared. Specifically, when it is determined that the outside air heat absorbing/heating operation is disabled until the destination is reached (when “defrosting necessary” is detected), a first total predicted power consumption amount is calculated when the device heat recovery/heating operation is executed without performing the defrosting operation until the destination is reached (the air conditioning operation pattern 1 or 2) and a second total predicted power consumption amount is calculated when the defrosting operation is performed until the destination after the time point at which the outside air heat absorbing/heating operation is disabled and the outside air heat absorbing/heating operation is executed after the defrosting (any one of the air conditioning operation patterns 3 to 5), and the defrosting operation is executed when the first total predicted power consumption amount is larger than the second total predicted power consumption amount.

That is, the controller 200 selects the air conditioning operation pattern having the smallest predicted power consumption amount among the air conditioning operation patterns 1 to 5. The controller 200 performs actual control in accordance with the selected air conditioning operation pattern.

In this manner, the controller 200 can select the device heat recovery/heating operation and the defrosting operation based on the real-time destination information.

With this configuration, it is possible to determine the presence or absence of the defrosting operation by comparing the power used for defrosting with the energy saving effect obtained by defrosting, and to avoid wasteful execution of the defrosting operation. That is, it is possible to optimize the consumed energy at the time of determining whether the defrosting operation is performed, and it is possible to suppress the decrease in the cruising distance.

(2) Determine the Start Time of the Defrosting Operation when the Defrosting Operation is Performed.

In this case, for example, the predicted power consumption amounts of the air conditioning operation patterns 3 to 5 are compared. Then, the controller 200 (defrosting timing determination unit 224) determines the actual execution timing of the defrosting operation based on the total predicted power consumption amount.

By comparing the predicted power consumption amount of the air conditioning operation patterns 3 to 5 and selecting and executing the air conditioning operation pattern having the minimum value, it is possible to determine the optimum start timing of the defrosting operation for execution. Specifically, the controller 200 selects one operation having the smallest total predicted power consumption amount from among the defrosting operation (air conditioning operation pattern 3), the defrosting operation (air conditioning operation pattern 4), and the defrosting operation (air conditioning operation pattern 5) immediately after the frost formation amount reaches the outside air heat absorption disable level α, and determines the actual execution timing of the defrosting operation based on the selected one.

Alternatively, in the simulation of the air conditioning operation patterns 3 to 5, the defrosting timing determination unit 224 selects a defrosting timing candidate based on the external information of a plurality of arbitrary points on the travel route, so that the defrosting operation can be started not only at the delayed execution/early execution based on the time point at which the outside air heat absorption disable level α is reached but also at the time point at which the defrosting can be efficiently performed (there is a possibility.)

Since the defrosting operation can be determined based on the real-time external information in this manner, it is possible to optimize the determination of the defrosting operation. As a result, it is possible to optimize the consumed energy and suppress a decrease in the cruising distance.

### (3) Control of Necessity of the Defrosting Operation and the Defrosting Operation.

In this case, for example, at least one of the air conditioning operation patterns 6 to 8 is simulated. By performing the necessary defrosting operation first immediately after the detection of “defrosting necessary (time)”, the outside air heat absorbing/heating operation can be performed up to the destination after the defrosting operation. Therefore, it is possible to reduce the possibility that the performance of the outside air heat absorbing/heating operation is wasted in the vicinity of the destination (at the end of traveling). In addition, since the defrosting operation is performed in a stage where the progress of the frosting is small, it is also possible to reduce the power consumption related to the defrosting operation.

Note that in this case, the controller 200 does not necessarily have to perform the simulation of the air conditioning operation patterns 6 to 8 and select and execute any one of the air conditioning operation patterns. For example, a configuration may be provided in which the air conditioning operation pattern 7 is simulated and executed alone.

In addition, for example, the frost formation amount in the vicinity of the destination may be compared on at least two patterns of the air conditioning operation patterns 6 to 8, and one closer to the outside air heat absorption disable level α may be selected and actually executed. As a result, this enables further reduction in the possibility that the performance of the outside air heat absorbing/heating operation is wasted.

As described above, the predicted power consumption amount does not necessarily have to be compared on the air conditioning operation patterns 6 to 8, and in that case, the predicted power consumption does not necessarily have to be calculated. Of course, the predicted power consumption amount may be compared between at least two patterns of the air conditioning operation patterns 6 to 8, and the minimum pattern may be actually executed.

(4) Control of the Outside Air Heat Absorbing/Heating Operation with Excellent Efficiency.

In this case, for example, at least one of the air conditioning operation patterns 9 and 10 is simulated.

In any of the patterns, when the vehicle arrives at the destination, the external heat exchange unit 7 controls the heat absorption amount such that the frost formation amount does not allow outside air heat absorption, so that the outside air heat absorbing/heating operation with high system efficiency can be executed from the current location to the destination, and the traveling can be ended in the outside air heat absorbing/heating operation. As a result, it is possible to suppress an increase in consumed energy.

Note that in this case, the controller 200 does not necessarily have to perform the simulation of both the air conditioning operation patterns 9 and 10 and select and execute either one. For example, a configuration may be provided in which the air conditioning operation pattern 9 is simulated and executed alone.

In addition, the predicted power consumption amount does not necessarily have to be compared between the air conditioning operation patterns 9 and 10. In this case, the predicted power consumption amount does not necessarily have to be calculated.

Alternatively, under the same condition, it is assumed that the air conditioning operation pattern 9 in which the heating comfort in the vehicle is slightly sacrificed and the air conditioning operation pattern in which the heating comfort is improved are larger in the latter as far as the power consumption amount is limited. In addition, therefore, the controller 200 may compare the air conditioning operation pattern 9 and the air conditioning operation pattern 10 under different conditions, and select and execute the air conditioning operation pattern 9 and the air conditioning operation pattern. Specifically, for example, the frost formation amount in the vicinity of the destination may be compared on each of the air conditioning operation patterns 9 and 10, and one closer to the outside air heat absorption disable level α may be selected and actually executed. As a result, this enables further reduction in the possibility that the performance of the outside air heat absorbing/heating operation is wasted. Of course, the predicted power consumption amount may be compared on the patterns of the air conditioning operation patterns 9 and 10, and a small pattern may be actually executed.

In addition, the present invention is not limited to the above cases, and beyond the range of the above cases, for example, at least two of the air conditioning operation patterns 1 to 10 may be selected and simulated, or all the predicted power consumption amounts of the air conditioning operation patterns 1 to 10 may be compared, and the minimum pattern may be selected and executed among the patterns 1 to 10.

For example, when at least one of the air conditioning operation patterns 1 to 10 is simulated and the optimum air conditioning operation pattern is determined, the controller 200 automatically executes the determined air conditioning operation pattern. However, the present invention is not limited to this, and when an optimal air conditioning operation pattern is determined, the determined air conditioning operation pattern may be executed based on some trigger (instruction.)

For example, the optimum air conditioning operation pattern may be notified (display on a car navigation display, and output voices) to the driver, and the air conditioning operation pattern may be executed in response to the determination operation by the driver. In addition, all the simulated air conditioning operation patterns may be notified and selected by the driver. At that time, when a pattern different from the optimal air conditioning operation pattern is selected, the determination operation by the driver may be preferentially executed, or the optimal air conditioning operation pattern may be preferentially executed.

The air conditioning operation patterns 1 to 10 are not simulated under predetermined conditions, but are simulated by acquiring the latest (real-time) destination information and external information each time, so that the accuracy is high and the energy saving effect can be enhanced.

As a result, it is possible to provide a vehicle air-conditioning apparatus capable of enhancing the energy saving effect by selectively executing the optimum operation control until the vehicle reaches the destination.

In addition, it is possible to provide a vehicle air-conditioning apparatus capable of enhancing the energy saving effect by determining the optimum execution timing of the defrosting operation until the vehicle reaches the destination.

In addition, it is possible to provide a vehicle air-conditioning apparatus capable of suppressing waste of power by avoiding execution of unnecessary defrosting operation and utilizing the performance of the outside air heat absorbing/heating operation as much as possible.

### <Air Conditioning Operation Control Method>

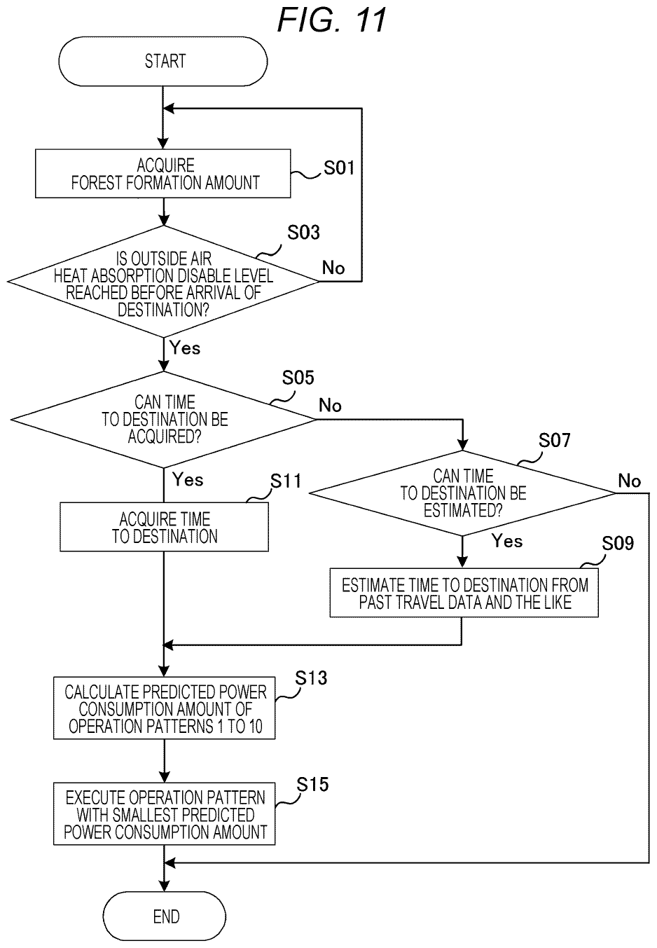

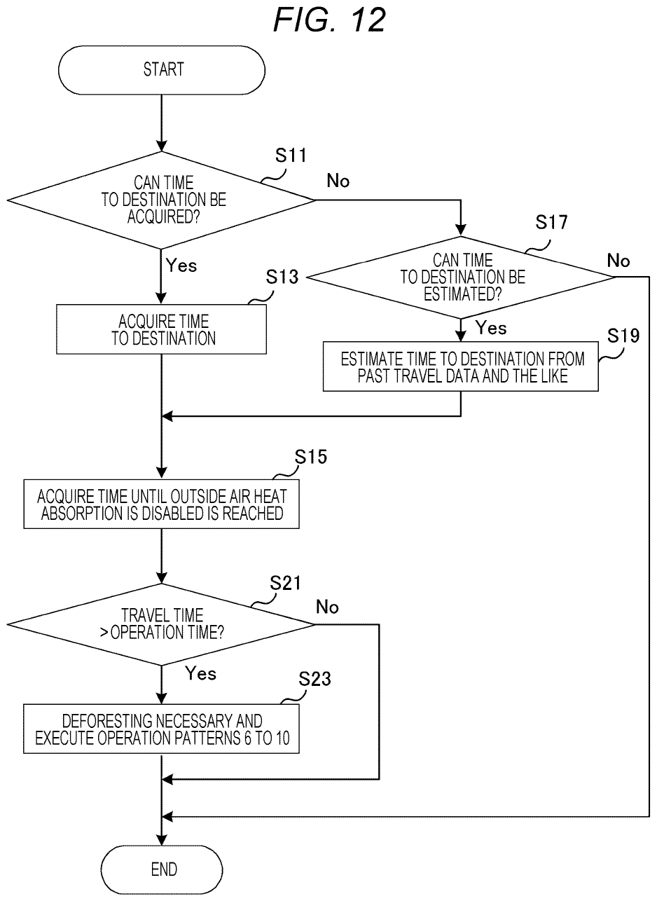

An air conditioning operation control method will be described with reference to FIGS. 11 and 12. FIGS. 11 and 12 are flowcharts showing an example of an air conditioning operation control method.

First, FIG. 11 is a flowchart showing processing in a case where each (or any) of the air conditioning operation patterns 1 to 10 is simulated, and a pattern with the minimum predicted power consumption amount is selected and executed.

First, in Step S01, the frost formation amount prediction unit 222 intermittently predicts the frost formation amount at the destination. In Step S03, it is determined whether “defrosting necessary” has been detected, that is, whether the frost formation amount (predicted value) reaches the outside air heat absorption disable level α before arrival at the destination. The air conditioning operation patterns 6 to 10 are predicted including time parameters. When “defrosting necessary” is detected, the process proceeds to Step S05, whereas when it is not detected, the process returns to Step S01.

In Step S05, it is determined whether the time to the destination can be acquired. When the time to the destination can be acquired, the process proceeds to Step S11, whereas when the time to the destination is unfeasible to be acquired, the process proceeds to Step S07. In Step S11, the time to the destination is acquired, and the process proceeds to Step S13. In Step S07, it is determined whether there is past travel history data (similar path, day of week, time, and the like) from which a destination can be estimated. When there is the travel history data, the process proceeds to step S09, and when there is no travel history data, the process ends. In Step S09, the destination and the time to the destination are estimated, and the process proceeds to Step S13.

In Step S13, a simulation is performed for each (or any) of the air conditioning operation patterns 1 to 10 to calculate a total predicted power consumption amount. In Step S15, an air conditioning operation pattern with the smallest total predicted power consumption amount is selected and executed.

FIG. 12 shows a flow of processing in a case where the defrosting necessity including the time parameter is detected specifically on the air conditioning operation patterns 6 to 10.

First, in Step S11, it is determined whether the travel time to the destination can be acquired. When the travel time can be acquired, the process proceeds to Step S13, and when the travel time is unfeasible to be acquired, the process proceeds to Step S17. In Step S13, the travel time to the destination is acquired, and the process proceeds to Step S15. In Step S17, it is determined whether there is past travel history data (similar path, day of week, time, and the like) from which a destination can be estimated. When there is the travel history data, the process proceeds to step S19, and when there is no travel history data, the process ends. In Step S19, the destination and the travel time to the destination are estimated, and the process proceeds to Step S15.

In step S15, outside air heat absorbing/heating executable time is calculated. The outside air heat absorbing/heating executable time is a value based on the frost formation variation calculated by the frost formation amount prediction unit 222 based on the destination information, and the accuracy can be improved by calculating the outside air heat absorbing/heating executable time based on the frost formation variation.

In Step S21, it is determined whether the travel time to the destination is longer than outside air heat absorbing/heating executable time. When the travel time is longer than the outside air heat absorbing/heating executable time, it is determined that the defrosting operation is necessary, and the process proceeds to Step S23. Otherwise, the process ends.

In Step S23, the defrosting operation is performed on each (desired pattern) of the air conditioning operation patterns 6 to 10, and then the outside air heat absorbing/heating operation is performed such that the outside air heat absorbing/heating executable time is equal to or longer than the travel time, and the process is ended.

In this manner, the predicted power consumption amount does not have to be calculated (compared) with respect to the plurality of air conditioning operation patterns 6 to 10. In addition, this processing may be performed by the controller 200 as a simulation or may be performed as processing during actual driving.

### Second Embodiment

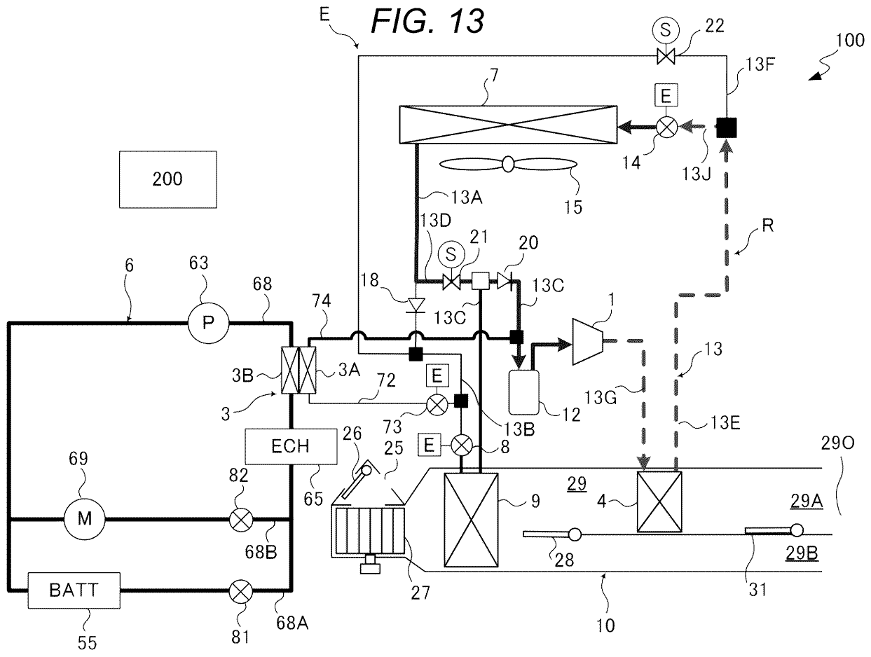

A second embodiment of the present invention will be described with reference to FIGS. 13 to 16. FIGS. 13 to 16 are schematic diagrams showing an example of a main configuration including a refrigerant circuit R of a vehicle air-conditioning apparatus 100 according to the second embodiment of the present invention.

The vehicle air-conditioning apparatus 100 according to the second embodiment is of a type that heats air in the condenser of the refrigerant circuit R. An air conditioning circuit E includes the refrigerant circuit R, an indoor heat exchange unit 4, and an external heat exchange unit 7. The air conditioning circuit E in this example has a configuration in which the indoor heat exchange unit 4 and the external heat exchange unit 7 are disposed on the refrigerant circuit R including a compressor 1.

Referring to FIG. 13, the vehicle air-conditioning apparatus 100 includes the electric compressor (electric compressor) 1 that compresses a refrigerant, the indoor heat exchange unit (radiator) 4 that is provided in an air flow passage 29 of an HVAC unit 10 through which air in a vehicle interior circulates and through which a high-temperature and high-pressure refrigerant discharged from the compressor 1 flows in via a refrigerant pipe 13G and dissipates the heat of the refrigerant to heat the air supplied into the c, an outdoor expansion valve 14 including an electric valve that decompresses and expands the refrigerant at the time of heating, the external heat exchange unit 7 performing heat exchange between the refrigerant and the outside air that functions as a radiator that dissipates heat of the refrigerant at the time of cooling and functions as an evaporator that absorbs heat of the refrigerant at the time of heating, and an indoor expansion valve 8 including an electric valve that decompresses and expands the refrigerant, a heat sink 9 provided in the air flow passage 29 and configured to cool the air supplied from the inside and outside of the vehicle interior to the inside of the vehicle interior by causing the refrigerant to absorb heat during cooling and dehumidification, and an accumulator 12 and the like are sequentially connected by a refrigerant pipe 13 to form a refrigerant circuit R. The outdoor expansion valve 14 and the indoor expansion valve 8 decompress and expand the refrigerant, and are also fully opened and fully closed.

The external heat exchange unit 7 is provided with an outdoor blower 15. The outdoor blower 15 forcibly ventilates the outside air to the external heat exchange unit 7 to exchange heat between the outside air and the refrigerant, and thus the outside air is ventilated to the external heat exchange unit 7 even while the vehicle is stopped (that is, the vehicle speed is 0 km/h.)

In addition, a refrigerant pipe 13A connected to the refrigerant outlet side of the external heat exchange unit 7 is connected to a refrigerant pipe 13B via a check valve 18. The check valve 18 has a forward direction on the refrigerant pipe 13B side, and the refrigerant pipe 13B is connected to the indoor expansion valve 8.

The refrigerant pipe 13A from the external heat exchange unit 7 is branched, and a branched refrigerant pipe 13D is connected in communication with a refrigerant pipe 13C located on the outlet side of the heat sink 9 via an electromagnetic valve 21 opened at the time of heating. A check valve 20 is connected to the refrigerant pipe 13C on the downstream side of the connection point of the refrigerant pipe 13D, the refrigerant pipe 13C on the downstream side of a check valve 20 is connected to the accumulator 12, and the accumulator 12 is connected to the refrigerant suction side of the compressor 1. Note that the check valve 20 is forward on the accumulator 12 side.

A refrigerant pipe 13E on the outlet side of a radiator 4 branches into a refrigerant pipe 13J and a refrigerant pipe 13F before the outdoor expansion valve 14 (refrigerant upstream side), and one of the branched refrigerant pipes 13J is connected to the refrigerant inlet side of the external heat exchange unit 7 via the outdoor expansion valve 14. In addition, the other branched refrigerant pipe 13F is communicatively connected to a refrigerant pipe 13B located on the refrigerant downstream side of the check valve 18 and on the refrigerant upstream side of the indoor expansion valve 8 via an electromagnetic valve 22 opened at the time of dehumidification.

As a result, the refrigerant pipe 13F is connected in parallel to the series circuit of the outdoor expansion valve 14, the external heat exchange unit 7, and the check valve 18, and becomes a circuit that bypasses the outdoor expansion valve 14, the external heat exchange unit 7, and the check valve 18.

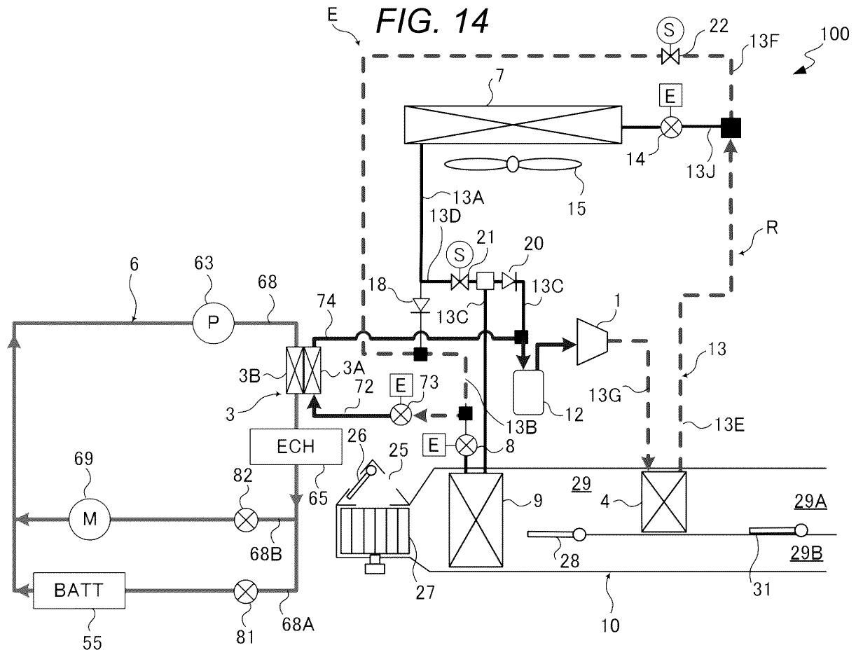

In the air flow passage 29 on the air upstream side of the heat sink 9, suction ports, an outside air suction port and an inside air suction port, are formed (represented by a suction port 25 in FIG. 14.) In addition, the suction port 25 is provided with a suction switching damper 26 that switches air to be introduced into the air flow passage 29 between inside air (inside air circulation) that is air inside the vehicle interior and outside air (outside air introduction) that is air outside the vehicle interior. Furthermore, on the air downstream side of the suction switching damper 26, an indoor blower 27 that feeds the introduced inside air and outside air to the air flow passage 29 is provided.

In the air flow passage 29 on the air upstream side of the radiator 4, an air mix damper 28 that adjusts a ratio of the air (inside air or outside air) in the air flow passage 29 after passing through the heat sink 9 to the radiator 4 is provided. Further, in the air flow passage 29 on the air downstream side of the radiator 4, respective blow-out ports (represented by blow-out ports 290 in FIG. 13) of a FOOT (foot), a VENT (vent), and a DEF (differential) are formed, and the blow-out port 290 is provided with a blow-out port switching damper 31 that performs switching control of blow-out of air from the respective blow-out ports.

Further, the vehicle air-conditioning apparatus 100 includes a temperature control target temperature adjustment device (heat medium circuit) 6 that adjusts the temperatures of a battery 55 and a traveling motor 69 by circulating a heat medium in the battery 55 and the traveling motor 69. In the embodiment, the battery 55 and the traveling motor 69 are temperature-controlled objects mounted on the vehicle. Note that the traveling motor 69 as the object to be temperature-controlled in the present invention is not limited to the electric motor itself, and has a concept including an electric device such as an inverter circuit for driving the electric motor.

The temperature control target temperature adjustment device (heat medium circuit) 6 of the embodiment includes a circulation pump 63 as a circulation device that circulates a heat medium to the battery 55 and the traveling motor 69, a heat exchanger 3 (refrigerant-heat medium heat exchanger), and an ECH 65, and the battery 55 and the traveling motor 69 are connected by a heat medium pipe 68. The ECH 65, the battery 55, and the traveling motor 69 correspond to the heat supply device in the first embodiment.

In the case of this embodiment, the inlet of a heat medium channel 3B of a refrigerant-heat medium heat exchanger 3 is connected to the discharge side of the circulation pump 63, and the outlet of the heat medium channel 3B is connected to the ECH 65 and branches into a heat medium pipe 68A and a heat medium pipe 68B at the tip. A series circuit of a first electromagnetic valve 81 as a channel controller and a battery 55 is connected to the heat medium pipe 68A, and a series circuit of a second electromagnetic valve 82 as a channel controller and a traveling motor 69 is connected to the heat medium pipe 68B. The heat medium pipe 68A on the outlet side of the battery 55 and the heat medium pipe 68B on the outlet side of the traveling motor 69 are joined and then connected to the suction side of the circulation pump 63. Note that the electromagnetic valves 81 and 82 may be constituted of an electric valve capable of adjusting the flow rate.

When the circulation pump 63 is operated in a state where the electromagnetic valves 81 and 82 are opened, the heat medium discharged from the circulation pump 63 flows into the heat medium channel 3B of the refrigerant-heat medium heat exchanger 3. The heat medium that has exited the heat medium channel 3B of the refrigerant-heat medium heat exchanger 3 is divided, one of the divided heat media reaches the battery 55 via the first electromagnetic valve 81, and the heat medium exchanges heat with the battery 55. The other divided heat medium reaches the traveling motor 69 via the second electromagnetic valve 82, and the heat medium exchanges heat with the traveling motor 69 there. The heat medium heat-exchanged with the battery 55 and the traveling motor 69 merges and is sucked into the circulation pump 63 to be circulated in the heat medium pipe 68. In addition, when the first electromagnetic valve 81 is closed, the heat medium does not flow to the battery 55, and when the second electromagnetic valve 82 is closed, the heat medium does not flow to the traveling motor 69.

On the other hand, one end of a branch pipe 72 as a branch circuit is connected to the refrigerant pipe 13B which is an outlet of the refrigerant pipe 13F of the refrigerant circuit R and is located on the refrigerant upstream side of the indoor expansion valve 8. The branch pipe 72 is provided with an auxiliary expansion valve 73 including an electric valve. The auxiliary expansion valve 73 decompresses and expands the refrigerant flowing into the refrigerant channel 3A of the refrigerant-heat medium heat exchanger 3 and can also be fully closed.

The other end of the branch pipe 72 is connected to the refrigerant channel 3A of the refrigerant-heat medium heat exchanger 3, one end of a refrigerant pipe 74 is connected to the outlet of the refrigerant channel 3A, and the other end of the refrigerant pipe 74 is connected to the refrigerant pipe 13C on the refrigerant downstream side of the check valve 20 and before the accumulator 12 (refrigerant upstream side.) The auxiliary expansion valve 73 and the like also constitute a part of the refrigerant circuit R and, at the same time, also constitute a part of the temperature control target temperature adjustment device 6.

When the auxiliary expansion valve 73 is open, the refrigerant (a part or all of the refrigerant) flowing out of the refrigerant pipe 13F and the external heat exchange unit 7 flows into the branch pipe 72, is decompressed by the auxiliary expansion valve 73, then flows into the refrigerant channel 3A of the refrigerant-heat medium heat exchanger 3, and evaporates there. The refrigerant absorbs heat from the heat medium flowing through the heat medium channel 3B while flowing through the refrigerant channel 3A, and then is sucked into the compressor 1 via the accumulator 12.

Under the condition that frost is formed on the external heat exchange unit 7 and external heat is unfeasible to be absorbed, the refrigerant that bypasses the external heat exchange unit 7 is subjected to heat exchange with the heat medium heated by the ECH 65, and thus the ECH 65 becomes a heat absorbing source of the refrigerant circuit R. At this time, by also using waste heat of a heat supply device such as the battery 55 of the heat medium circuit 6 or the traveling motor 69, it is possible to suppress the amount of heat generation of the ECH 65 and suppress an increase in energy consumption.

In addition, in such a temperature control target temperature adjustment device 6, a heater that heats the heat medium flowing through the heat medium pipe 68A and the heat medium pipe 68B is provided upstream of the battery 55 and the traveling motor 69 in order to cause the battery 55 and the traveling motor 69 to exchange heat with the heat medium. In the present embodiment, since the ECH 65 is disposed on the upstream of the branch portion of the heat medium pipes 68A and 68B, it is unnecessary to dispose a heater in each of the heat medium pipes 68A and 68B, and the number of heaters can be reduced.

### <Air Conditioning Operation/Outside Air Heat Absorbing/Heating Operation>

First, an outside air heat absorbing/heating operation will be described with reference to FIG. 13. FIG. 13 shows a flow (arrow) of the refrigerant in the refrigerant circuit R during the heating operation. In the outside air heat absorbing/heating operation, the electromagnetic valve 21 is opened, and the indoor expansion valve 8 is fully closed. In addition, the electromagnetic valve 22 is closed.

Then, the compressor 1 and the blowers 15 and 27 are operated, and the air mix damper 28 adjusts the ratio of the air blown out from the indoor blower 27 to be ventilated to the radiator 4. As a result, the high-temperature and high-pressure gas refrigerant discharged from the compressor 1 flows into the radiator 4. Since the air in the air flow passage 29 is ventilated to the radiator 4, the air in the air flow passage 29 is heated by the high-temperature refrigerant in the radiator 4, while the refrigerant in the radiator 4 is deprived of heat by the air, cooled, and condensed and liquefied.

The refrigerant liquefied in the radiator 4 exits the radiator 4, and then reaches the outdoor expansion valve 14 via the refrigerant pipes 13E and 13J (indicated by broken arrows in FIG. 13). The refrigerant flowing into the outdoor expansion valve 14 is decompressed there, and then flows into the outdoor heat exchanger 7. The refrigerant that has flowed into the outdoor heat exchanger 7 evaporates, and pumps up heat (absorbs heat) by traveling or from outside air ventilated by the outdoor blower 15. That is, the refrigerant circuit R serves as a heat pump. The high-temperature refrigerant that has exited the outdoor heat exchanger 7 enters the accumulator 12 from the refrigerant pipe 13C via the refrigerant pipe 13A, the refrigerant pipe 13D, and the electromagnetic valve 21. After gas-liquid separation, the gas refrigerant is sucked into the compressor 1 (indicated by solid arrows in FIG. 13), and this circulation is repeated. The air heated by the radiator 4 is blown out from the blow-out port 290, so that the vehicle interior is heated.

### <Air Conditioning Operation/Device Heat Recovery/Heating Operation>

Next, a device heat recovery/heating operation will be described with reference to FIG. 14. In the device heat recovery/heating operation, the electromagnetic valve 22 is opened and the outdoor expansion valve 14 is closed. In addition, the auxiliary expansion valve 73 is opened to control the valve opening. Then, the circulation pump 63 of the temperature control target temperature adjustment device (heat medium circuit) 6 is operated. As a result, the refrigerant discharged from the radiator 4 reaches the refrigerant upstream side of the indoor expansion valve 8 via the refrigerant pipe 13F (indicated by a broken arrow in FIG. 14). The refrigerant is then decompressed by the auxiliary expansion valve 73, and flows into the refrigerant channel 3A of the heat exchanger (refrigerant-heat medium heat exchanger) 3 via the branch pipe 72 to be evaporated. At this point in time, the endothermic effect is exerted. The refrigerant evaporated in the refrigerant channel 3A repeats circulation in which the refrigerant sequentially passes through the refrigerant pipe 74 and the accumulator 12 and is sucked into the compressor 1 (indicated by solid arrows in FIG. 14).

On the other hand, the heat medium discharged from the circulation pump 63 reaches the heat medium channel 3B of the heat exchanger (refrigerant-heat medium heat exchanger) 3 in the heat medium pipe 68, where the heat medium is absorbed by the refrigerant evaporated in the refrigerant channel 3A, and the heat medium is cooled. The heat medium that has exited the heat medium channel 3B of the heat exchanger 3 is divided in a state where the first and second electromagnetic valves 81 and 82 are opened, and one divided heat medium reaches the battery 55 via the first electromagnetic valve 81 and exchanges heat with the battery 55. The other divided heat medium reaches the traveling motor 69 via the second electromagnetic valve 82, and exchanges heat with the traveling motor 69. Then, after the heat medium heat-exchanged with the battery 55 and the traveling motor 69 joins, the heat medium repeats circulation sucked into the circulation pump 63 (indicated by an arrow in FIG. 14).

### <Air Conditioning Operation/Defrosting Operation (Defrosting Heating Operation)>

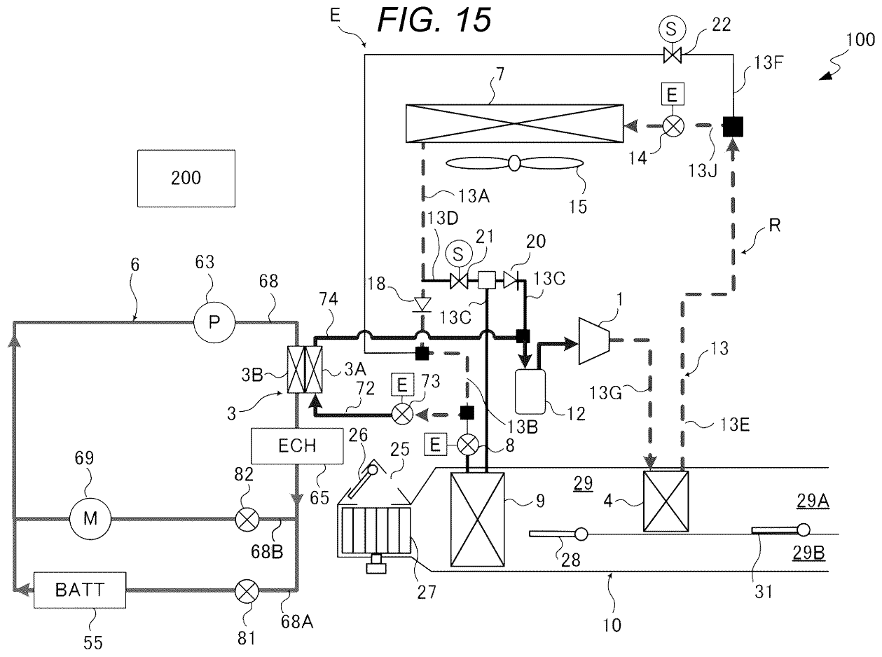

Next, a defrosting operation that defrosts the external heat exchange unit 7 will be described with reference to FIG. 15. In the defrosting operation, the compressor 1 is operated, and the outdoor blower 15 is stopped. In addition, the indoor expansion valve 8 is fully closed, and the auxiliary expansion valve 73 is opened to decompress the refrigerant. The outdoor expansion valve 14 is fully opened. Further, the electromagnetic valve 21 is closed. Then, the circulation pump 63 is operated to cause the refrigerant and the heat medium to exchange heat in the refrigerant-heat medium heat exchanger 3.

As a result, the high-temperature and high-pressure gas refrigerant discharged from the compressor 1 reaches the outdoor expansion valve 14 from the refrigerant pipe 13E via the radiator 4. At this time, since the outdoor expansion valve 14 is fully opened, the refrigerant passes through the refrigerant pipe 13J and flows into the external heat exchange unit 7 as it is. The external heat exchange unit 7 is defrosted by the high-temperature gas refrigerant flowing into the external heat exchange unit 7. The refrigerant dissipates heat, condenses and liquefies, and then exits from the external heat exchange unit 7.

The refrigerant that has exited the external heat exchange unit 7 enters the refrigerant pipe 13B via the refrigerant pipe 13A. At this time, since the indoor expansion valve 8 is fully closed, all the refrigerant that has exited the external heat exchange unit 7 is decompressed by the auxiliary expansion valve 73, then flows into the refrigerant channel 3A of the refrigerant-heat medium heat exchanger 3, and evaporates. At this point in time, the endothermic effect is exerted. The refrigerant evaporated in the refrigerant channel 3A is repeatedly circulated and sucked into the compressor 1 through the refrigerant pipe 74, the refrigerant pipe 13C, and the accumulator 12 in this order.

On the other hand, in a state where the electromagnetic valves 81 and 82 are opened, the heat medium discharged from the circulation pump 63 flows into the heat medium channel 3B of the refrigerant-heat medium heat exchanger 3. The heat medium that has exited the heat medium channel 3B of the refrigerant-heat medium heat exchanger 3 is heated by the ECH 65 and then diverted. One of the divided heat mediums reaches the battery 55 through the first electromagnetic valve 81, and the heat medium exchanges heat with the battery 55 there. The other divided heat medium reaches the traveling motor 69 via the second electromagnetic valve 82, and the heat medium exchanges heat with the traveling motor 69 there. The heat medium heat-exchanged with the battery 55 and the traveling motor 69 merges and is sucked into the circulation pump 63 to be circulated in the heat medium pipe 68.

In the defrosting operation under the condition that external heat is unfeasible to be absorbed due to frosting at the external heat exchange unit 7, both the heating operation and the defrosting operation are achieved by using the ECH 65 as a heat source for defrosting and heating. At this time, by also using waste heat of a heat supply device such as the battery 55 of the heat medium circuit 6 or the traveling motor 69, it is possible to suppress the amount of heat generation of the ECH 65 and suppress an increase in energy consumption.

### <Air Conditioning Operation/Combined Heating Operation>

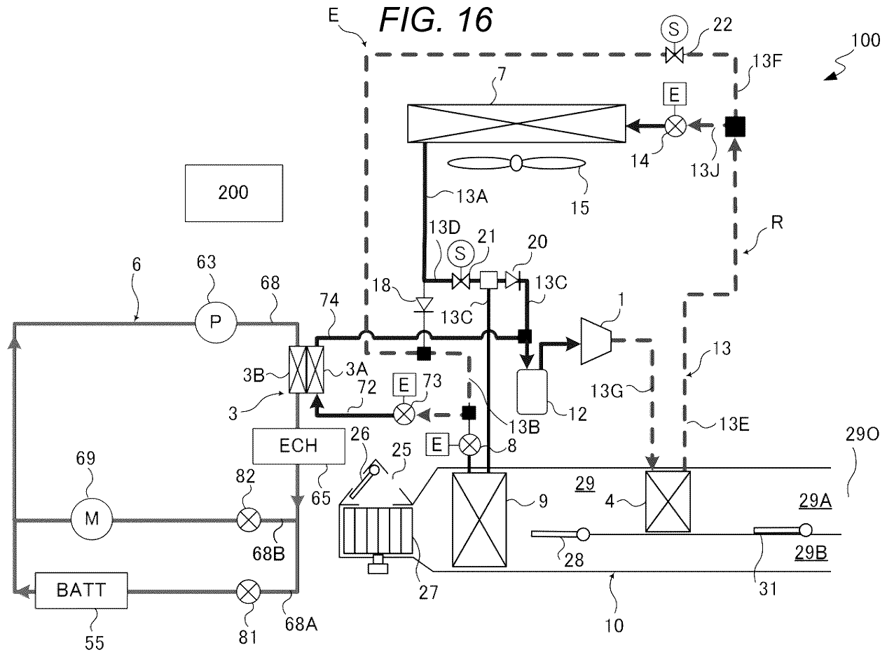

Next, a combined heating operation will be described with reference to FIG. 16. In the device heat recovery/heating operation shown in FIG. 15, the outdoor expansion valve 14 is opened, the grill fan (not shown) of the external heat exchange unit 7 is opened, and the outdoor blower 15 is operated. Then, the circulation pump 63 of the temperature control target temperature adjustment device 6 is operated. As a result, a part of the refrigerant discharged from the radiator 4 is divided on the refrigerant upstream side of the outdoor expansion valve 14, and reaches the refrigerant upstream side of the indoor expansion valve 8 via the refrigerant pipe 13F that bypasses the external heat exchange unit 7. The refrigerant then enters the branch pipe 72, is decompressed by the auxiliary expansion valve 73, flows into the refrigerant channel 3A of the refrigerant-heat medium heat exchanger 3 via the branch pipe 72, and evaporates. At this point in time, the endothermic effect is exerted. The refrigerant evaporated in the refrigerant channel 3A is repeatedly circulated and sucked into the compressor 1 through the refrigerant pipe 74, the refrigerant pipe 13C, and the accumulator 12 in this order.

A part of the refrigerant flowing out of the radiator 4 reaches the outdoor expansion valve 14, is decompressed there, and then flows into the external heat exchange unit 7. The refrigerant that has flowed into the external heat exchange unit 7 evaporates, and pumps up heat (absorbs heat) by traveling or from outside air ventilated by the outdoor blower 15. That is, the refrigerant circuit R serves as a heat pump. Then, the low-temperature refrigerant that has exited the external heat exchange unit 7 enters the accumulator 12 via the refrigerant pipe 13A, the refrigerant pipe 13D, the electromagnetic valve 21, and the check valve 20, and repeats circulation in which the gas refrigerant is sucked into the compressor 1 after being separated into gas and liquid. Since the air heated by the radiator 4 is blown out from the blow-out port 290, and thus heating of the vehicle interior is performed.

In the case of the air conditioning operation pattern 10, that is, in the combined heating operation in which the device heat recovery/heating operation (ECH heating operation) is supplementarily performed in order to suppress and compensate for the heating performance of the outside air heat absorbing/heating operation, the external heat exchange unit 7 and the ECH 65 are used as heat absorbing sources of the refrigerant circuit R. At this time, by also using waste heat of a heat supply device such as the battery 55 of the heat medium circuit 6 or the traveling motor 69, it is possible to suppress a calorific value of the ECH 65 and suppress an increase in consumed energy.

Under the condition that frost is formed on the external heat exchange unit 7 and external heat is unfeasible to be absorbed, the refrigerant that bypasses the external heat exchange unit 7 is subjected to heat exchange with the heat medium heated by the ECH 65, and thus the ECH 65 becomes a heat absorbing source of the refrigerant circuit R. At this time, by also using waste heat of a heat supply device such as the battery 55 of the heat medium circuit 6 or the traveling motor 69, it is possible to suppress the amount of heat generation of the ECH 65 and suppress an increase in energy consumption.

### Third Embodiment

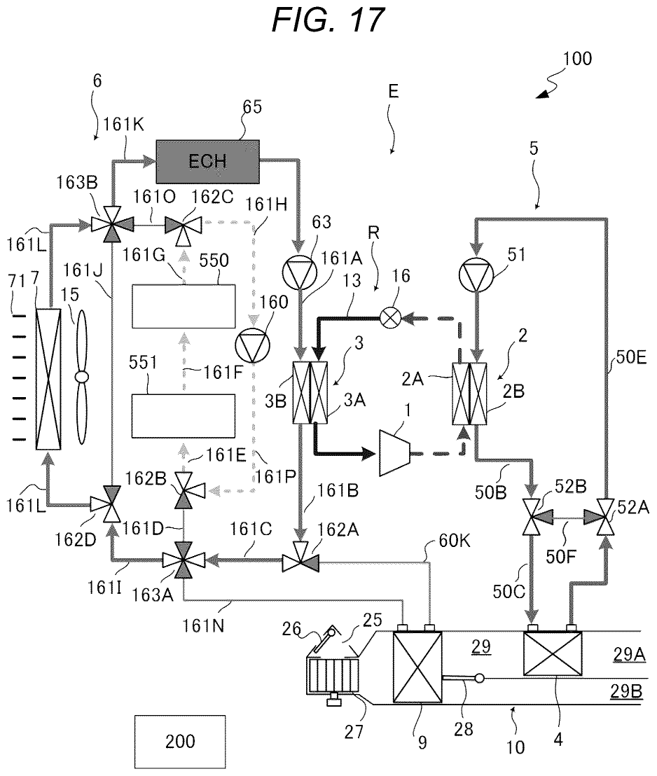

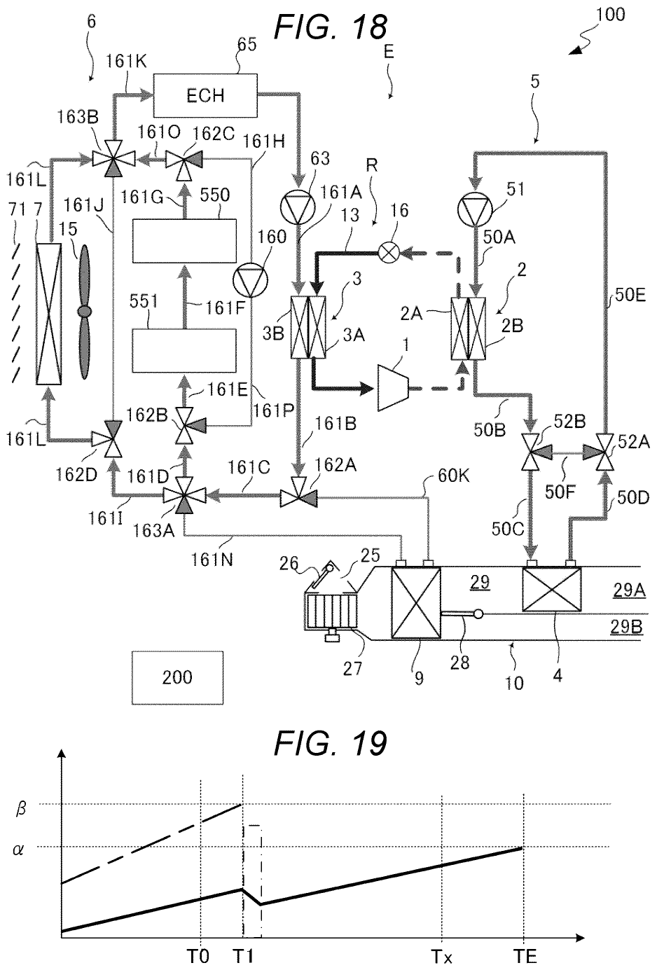

A third embodiment of the present invention will be described with reference to FIGS. 17 and 18. FIGS. 17 and 18 are schematic diagrams showing an example of a main configuration including a refrigerant circuit R in a vehicle air-conditioning apparatus 100 according to the third embodiment of the present invention. In the circuits shown in FIGS. 17 and 18, the function of the device (configuration) that are filled is stopped. In addition, the movement of the heat medium and the refrigerant is indicated by arrows.

The third embodiment is an air conditioning circuit E of a type that heats air via a heat medium circuit similar to the first embodiment, and has a configuration in which a heat storage section (heat storage unit 550) and a heat generator 551 are further included in a second heat medium circuit 6. Configurations of the refrigerant circuit R, a first heat medium circuit 5, and an HVAC unit 10 are similar to those of the first embodiment, and thus the description is omitted, and a second heat medium circuit 6 will be described.

The second heat medium circuit 6 of the third embodiment is a circuit in which a heat medium capable of exchanging heat with the refrigerant of a heat supply device 65 and the refrigerant circuit R circulates, and includes, for example, a circulation pump 63, a second heat exchanger 3, a radiator that is an external (outdoor) heat exchange unit 7, a heat supply device (ECH) 65, pipes 161 (161A to 161P), a three-way valve 162 (162A to 162D), four-way valves 163A and 163B, and the like.

The outlet of the circulation pump 63 communicates with the heat medium channel 3B of the second heat exchanger 3 via the pipe 161A. The heat medium channel 3B is connected to one inlet of the four-way valve 163A via the pipe 161B, the three-way valve 162A, and the pipe 161C. In the four-way valve 163A, the pipe 161C is connected to one inlet, the pipe 161N is connected to the other inlet, the pipe 161D is connected to one outlet, and the pipe 161I is connected to the other outlet. The pipe 161D is connected to the heat generator 551 via the three-way valve 162B and the pipe 161E, and the heat generator 551 is connected to the heat storage unit 550 via the pipe 161F. The heat storage unit 550 is connected to the inlet of the three-way valve 162C via the pipe 161G. The three-way valve 162C has one outlet connected to the pipe 161H and the other outlet connected to the four-way valve 163B via the pipe 161O. The pipe 161H is connected to an inlet of the circulation pump 160, and an outlet of the circulation pump 160 is connected to the three-way valve 162B via the pipe 161P.

In the three-way valve 162D, the pipe 161I is connected to the inlet, the pipe 161J is connected to one outlet, and the pipe 161L is connected to the other outlet. The pipe 161J is connected to the first inlet of the four-way valve 163B, the pipe 161O is connected to the second inlet of the four-way valve 163B, and the pipe 161L is connected to the third inlet. An outlet of the four-way valve 163B communicates with one end of the ECH 65 via the pipe 161K. The other end of the ECH 65 is connected to the inlet of the circulation pump 63 via the pipe 161A. One outlet of the three-way valve 162D is connected to one end of the external heat exchange unit 7 through the pipe 161L, and the other end of the external heat exchange unit 7 is connected to the four-way valve 163B through the pipe 161L.

FIG. 17 is a circuit diagram that stores heat in addition to the outside air heat absorbing/heating operation, and the circulation of the refrigerant and the heat medium is indicated by arrows. When heat is stored in addition to the outside air heat absorbing/heating operation, the four-way valve 163A is opened such that the pipes 161C and 161I communicate with each other, and a space between the pipe 161N and the pipe 161D is closed. The three-way valve 162B is opened such that the pipes 161P and 161E communicate with each other, and the three-way valve 162C is opened such that the pipes 161G and 161H communicate with each other. The three-way valve 162D is opened such that the pipes 161I and 161L communicate with each other, and the four-way valve 163B is opened such that the pipes 161L and 161K communicate with each other.

As a result, the refrigerant and the heat medium are circulated in the refrigerant circuit R, the first heat medium circuit 5, and the second heat medium circuit 6, and the outside air heat absorbing/heating operation is performed in the same operation as in the first embodiment. In the third embodiment, in addition to this, the heat generator 551, the pipe 161 F, the heat storage unit 550, the pipe 161G, the pipe 161H, and the circulation pump 160 form a closed channel, and the heat medium is circulated through the closed channel by the circulation pump 160. The heat medium absorbs heat when passing through the heat generator 551, and dissipates heat in the heat storage unit 550. This process is repeated, and the heat storage unit 550 stores heat.

Under the condition where outside air heat can be absorbed as described above, the outside air heat is absorbed by the external heat exchange unit 7 and used as a heat absorption source of the refrigerant circuit R. In addition, the heat storage unit 550 stores heat by circulation of the heat medium. However, when a heat supply device such as a battery or a motor (not shown) is connected to the second heat medium circuit 6, for example, their waste heat is stored in the heat storage unit 550, and thus the heat storage unit can serve as a heat absorbing source heat generation supply source when outside air heat absorption becomes unfeasible. In addition, when heat storage can be used, the frost formation speed can be suppressed by using the heat absorption source of the heat storage unit 550.

FIG. 18 shows a circuit configuration that performs the defrosting operation and the heating operation. Here, the heating operation is a heating operation using the heat storage unit 550, the heat generator 551, and the ECH 65 as heat absorption sources, and corresponds to the device heat recovery/heating operation described above. That is, FIG. 18 is similar to the defrosting (heating) operation of the first embodiment.

In this case, the four-way valve 163A is opened such that the pipes 161C, 161D, and 161I communicate with each other, and the three-way valve 162B is opened such that the pipes 161D and 161E communicate with each other. The three-way valve 162C is opened such that the pipes 161G and 161O communicate with each other, the three-way valve 162D is opened such that the pipes 161I and 161L communicate with each other, and the four-way valve 163B is opened such that the pipes 161L, 161K, and 161O communicate with each other. As a result, the heat medium in the second heat medium circuit 6 forms a channel of the heat 551, the heat storage unit 550, the ECH 65, the circulation pump 63, and the second heat exchanger 3, and a channel that is divided from the channel by the four-way valve 163A, passes through the external heat exchange unit 7, and reaches the ECH 65.

Under the condition that the outside air heat is unfeasible to be absorbed due to the frosting of the external heat exchange unit 7, the heat medium that bypasses the external heat exchange unit 7 by the pipes 161E, 161 F, 161O, and 161K is heated by the ECH 65, so that the ECH 65 can be used as a heat absorption source of the refrigerant circuit R. At this time, when the heat storage unit 550 exceeds a predetermined heat storage amount that can be used as a heat absorption source, the heat storage unit 550 is also used as a heat absorption source, and thus an increase in energy consumed by the ECH 65 can be suppressed. As described above, according to the third embodiment, the heating operation by the heat storage unit 550 can be executed during the defrosting operation.

FIG. 19 is a diagram showing an example of the case in which the air-conditioning control is performed using the circuit of the third embodiment, and is a modification of the air conditioning operation pattern 7. In this example, when the heat storage amount (indicated by a thick chain line) of the heat storage unit 550 reaches a certain level (heat storage level B), the defrosting operation is executed only partially even before reaching the outside air heat absorption disable level α. Although it is detected at present time T0 that the outside air heat absorption disable level α is reached before the arrival at the destination (defrosting necessary), the defrosting operation is not immediately performed at time T0, and the defrosting operation (FIG. 18) is started at time T1 when the heat storage amount of the heat storage unit 550 reaches the heat storage level B. During the defrosting operation, the heat storage unit 550 can perform the heating operation. In this example, the defrosting operation is stopped before complete defrosting, and then the outside air heat absorbing/heating operation (FIG. 17) is executed.

In this example, when it is determined that the defrosting operation is not performed, the outside air heat absorbing/heating operation is continued regardless of whether the heat storage amount reaches the heat storage level B.

### Modified Example

### <Method of Calculating Frost Formation Variation>

The frost formation amount prediction unit 222 of the controller 200 may calculate (estimate) the frost formation variation by the following method.

### <1> Estimation of Present Frost Formation Amount

First, the present frost formation amount is estimated by any one of the following methods (1) to (3).

### (1) Method Using an Air Quantity Difference Between the Upstream Side and Downstream Side of the External Heat Exchanger (Radiator) 7

When frost is forming, the air passing through the radiator 7 decreases. Therefore, it is determined that frost is forming in a case where the air passing through the radiator 7 decreases. A correlation between the magnitude of the air quantity difference between the windward side and the leeward side of the radiator 7 and the frost formation amount is acquired in advance by an experiment or the like, and the present frost formation amount is estimated based on an actual measurement value of the air quantity difference between the windward side and the leeward side of the radiator 7 and the correlation acquired in advance when the vehicle travels.

### (2) Method Using a Difference Between the Outside Air Temperature and Outlet Water Temperature of the Radiator 7

When the difference between the outside air temperature and the outlet water temperature of the radiator 7 is large, it is determined that frost is forming because heat exchange has not been performed. The correlation between the magnitude of the temperature difference between the outside air temperature and the outlet water temperature of the radiator 7 and the frost formation amount is acquired in advance by experiments or the like, and the present frost formation amount is estimated from the measured value of the temperature difference between the outside air temperature and the outlet water temperature of the radiator 7 and the correlation acquired in advance when the vehicle travels.

### (3) Method Using a Difference in Water Temperature at the Inlet and Outlet of the Radiator 7

The heat exchange rate in the radiator 7 is calculated by calculating the difference between the inlet and outlet water temperatures of the radiator 7. When the difference between the inlet and outlet water temperatures (water temperature difference) is small, it is determined that frost is forming because heat exchange has not been performed. The correlation between the magnitude of the temperature difference between the inlet and outlet water temperatures of the radiator 7 and the frost formation amount is acquired in advance by experiments or the like, and the present frost formation amount is estimated from the measured value of the temperature difference between the inlet and outlet water temperatures of the radiator 7 and the correlation acquired in advance when the vehicle is traveling.

### <2> Estimation of Future Frost Formation Amount

Next, a future frost formation amount is estimated by any one of the following methods (1) and (2).

### (1) Prediction Based on Information of Various Sensors

A frost formation change rate (=(frost formation amount at point B-frost formation amount at point A)/travel time between points A and B) at a predetermined interval (e.g., points A to B) up to the present time is calculated based on the present (current) frost formation amount estimated by any one of the above methods (1) to (3) In addition to the above, operating conditions (target temperature of heating, outside air temperature and humidity, vehicle speed, traffic information, and the like) at that time is also stored. Then, a change in the operating conditions such as a change in outside air temperature and humidity to the destination is predicted based on the destination information, a frost formation variation is predicted based on the stored past operating condition and operating condition change, and a frost formation amount at a certain time point in the future is estimated.

(2) Prediction with Reference to Information Such as Experimental Results

A correlation between a target heating temperature and an outside air temperature and humidity and a frost formation variation is previously stored by an experiment or the like according to any one of the methods (1) to (3). The change in the outside air temperature and humidity to the destination is predicted based on the destination information, the future frost formation variation is predicted together with the heating target temperature, and the frost formation amount at a certain time point in the future is estimated.

These are merely examples, and the frost formation change rate or the future frost formation amount may be estimated by another known method.

According to the present embodiment described above, since the necessity of the defrosting operation is determined by comparing the power used in the defrosting operation with the energy saving effect obtained by the defrosting, it is possible to avoid the unnecessary defrosting operation, optimize the energy consumption related to the defrosting operation, and suppress the decrease in the cruising distance.

In addition, the conditions suitable for frost formation amount prediction and the defrosting operation are grasped using the external information and/or the destination information, and the necessity of the defrosting operation is determined, so that the accuracy of the determination of the defrosting operation is improved. As a result, it is possible to optimize consumed energy related to the defrosting operation and to suppress a decrease in cruising distance.

In addition, the defrosting operation can be performed at an optimum timing, and it is possible to enhance the energy saving effect.

Here, the present invention is not limited to the foregoing embodiments, and various modifications can be made without deviating from the gist of the present invention.

### LIST OF REFERENCE SIGNS

1 Compressor (electric compressor)
2A Refrigerant channel
2B Heat medium channel
3 Heat exchanger
3A Refrigerant channel
3B Heat medium channel
4 Indoor heat exchange unit (heater core)
6 Heat medium circuit
7 External heat exchange unit
8 Indoor expansion valve
10 HVAC unit
100 Vehicle air-conditioning apparatus
200 Controller (ECU)
220 Simulation unit
221 Information acquisition unit
222 Frost formation amount prediction unit
223 Power amount calculation unit
224 Defrosting timing determination unit
225 Heat absorption amount suppression control unit

1. A vehicle air-conditioning apparatus comprising:
an air conditioning circuit having a refrigerant circuit, an indoor heat exchange unit, and an external heat exchange unit, the refrigerant circuit including a compressor; and
a controller that controls the refrigerant circuit, the controller selectively executing an outside air heat absorbing/heating operation that absorbs heat in the external heat exchange unit and a defrosting operation that defrosts the external heat exchange unit, wherein
the controller calculates a travel time to a destination and operation time of an outside air heat absorbing/heating operation until outside air heat absorption becomes unfeasible in the external heat exchange unit due to frosting, and
when the travel time is longer than the operation time, the controller executes the defrosting operation such that at least the operation time is equal to or longer than the travel time.

2. The vehicle air-conditioning apparatus according to claim 1, wherein
the controller predicts a frost formation change rate of the external heat exchange unit based on destination information.

3. The vehicle air-conditioning apparatus according to claim 2, wherein
the controller calculates the operation time based on the frost formation change rate.

4. The vehicle air-conditioning apparatus according to claim 1, comprising a heat medium circuit through which a heat medium flows, wherein
the controller defrosts the external heat exchange unit with the heat medium during the defrosting operation.

5. The vehicle air-conditioning apparatus according to claim 4, wherein
during the defrosting operation, a device heat recovery/heating operation that absorbs heat from the heat medium flowing through the heat medium circuit is feasible.

6. The vehicle air-conditioning apparatus according to claim 1, comprising a heat storage section, wherein
during the defrosting operation, the heat storage section is feasible of performing a heating operation.

7. The vehicle air-conditioning apparatus according to claim 1, wherein
the defrosting operation is performed such that a frost formation amount at which the external heat exchange unit is unfeasible to absorb heat of the outside air is set to an outside air heat absorption disable level, and the frost formation amount at destination arrival time reaches 50% or more of the outside air heat absorption disable level.
